(19) United States
(12) Patent Application Publication
(10) Pub. No.: US 2026/0175453 A1
(43) Pub. Date: Jun. 25, 2026

(54) END-EFFECTORS FOR SAMPLE-HANDLING ROBOTIC SYSTEMS

(71) Applicant: EIKON THERAPEUTICS, INC., Millbrae, CA (US)

(72) Inventors: Ryan HOLLOWELL, Millbrae, CA (US); Kevin LIN, Millbrae, CA (US); Jeremy RINE, Millbrae, CA (US); Russell BERMAN, Millbrae, CA (US)

(73) Assignee: EIKON THERAPEUTICS, INC., Millbrae, CA (US)

(21) Appl. No.: 19/541,875

(22) Filed: Feb. 17, 2026

Related U.S. Application Data
(63) Continuation of application No. PCT/US2024/042701, filed on Aug. 16, 2024.
(60) Provisional application No. 63/520,573, filed on Aug. 18, 2023.

(51) Int. Cl. B25J 15/08; B25J 9/16; B25J 15/00

(52) U.S. Cl. CPC B25J 15/08; B25J 9/1679; B25J 15/0033

(57) ABSTRACT

The present disclosure is directed to end-effectors facilitating the interface between robotic systems and a wide variety of interfacing surfaces, e.g., standard microtiter plates and sample preparation workflow instruments, as well robotic systems comprising such end-effectors and methods of using such end-effectors and systems comprising such end-effectors. In certain embodiments, the end-effectors comprise a first gripper finger and a second gripper finger where the fingers are configured to be selectively separable from each other, each figure further comprises an extended member having an attachment end and a contact section opposite the attachment end, and the first gripper finger further comprises a rocker assembly comprising a rocker member facilitating the pivoting and gripping of the gripper fingers.

### CROSS-REFERENCE TO RELATED APPLICATIONS

This application is a continuation of International Patent Application No. PCT/US2024/042701, filed Aug. 16, 2024, which claims priority to U.S. Provisional Application No. 63/520,573, filed Aug. 18, 2023, the contents of each of which are incorporated by reference in their entireties, and to which priority is claimed.

### TECHNICAL FIELD

The present disclosure is directed to end-effectors facilitating the interface between robotic systems, e.g., sample-handling robotic systems, and a wide variety of interfacing surfaces, e.g., microtiter plates and sample preparation workflow instruments, as well robotic systems comprising such end-effectors, and methods of using such end-effectors and robotic systems comprising such end-effectors.

### BACKGROUND

Sample-handling robotic systems have significantly increased the throughput associated with laboratory analyses, particularly those analyses carried out on substrates designed for highly parallel analyses, e.g., analyses performed in multi-well microtiter plates, and/or requiring the movement of such substrates through specified workflow paths. Despite efforts to standardize such substrates and associated components and instrumentation, e.g., lids and containers of consumables (e.g., pipette tip containers), differences in materials, textures, and geometries can impede the use of single format end-effectors and thus may require the implementation of multiple sample-handling robots. Moreover, the workflow paths associated with sample-handling systems can include specific physical constraints. For example, a workflow path may include: a requirement for landscape or portrait substrate orientation; specific depths for particular recesses within various instruments in the path; as well as limitations on the available spatial clearance associated with aspects of the workflow path. In view of the foregoing, there remains a need in the field for end-effectors facilitating the interface between robotic systems and a wide variety of interfacing surfaces and capable of operating in a wide variety of workflow paths.

### SUMMARY OF THE INVENTION

In certain aspects, the compositions, systems, and methods described herein relate to end-effectors for robotic systems, e.g., sample-handling robotic systems, and methods of their use. In certain embodiments, the end-effectors comprise a first gripper finger and a second gripper finger. In certain embodiments, the first and second gripper fingers are configured to be selectively separable from each other. In certain embodiments, each of the first gripper finger and the second gripper finger respectively comprise an extended member having an attachment end and a contact section opposite the attachment end. In certain embodiments, the first gripper finger further comprises a rocker assembly. In certain embodiments, the rocker assembly comprises: (1) a rocker member having a proximal portion and a distal portion; (2) a pivoting connector assembly disposed between the proximal portion and the distal portion of the rocker member which can be configured to pivotally couple the rocker member to the contact section of the first gripper finger; and (3) a proximal gripper surface and a distal gripper surface respectively provided at the proximal portion and the distal portion of the rocker member. In certain embodiments, the second gripper finger further comprises an intermediate gripper surface provided at the contact section of the second gripper finger. In certain embodiments, the intermediate gripper surface is disposed between parallel planes respectively passing through the proximal gripper surface and the distal gripper surface. In certain embodiments, each of the proximal, intermediate, and distal gripper surfaces is configured to cooperatively engage with a respective interfacing surface.

In certain embodiments, the compositions and methods described herein relate to end-effectors where at least one gripper surface comprises one or more surface features to facilitate cooperative engagement with a respective interfacing surface. In certain embodiments, each of the surface features of the gripper surface converges toward the respective interfacing surface at a tip or an edge.

In certain embodiments, the compositions and methods described herein relate to end-effectors where a gripper surface comprises a metallic gripper pad or a plastic gripper pad. In certain embodiments, the compositions and methods described herein relate to end-effectors where a gripper surface comprises a gripper pad made of an elastomeric material capable of deforming under load to facilitate cooperative engagement with the respective interfacing surface.

In certain embodiments, the compositions and methods described herein relate to end-effectors comprising pivoting connector assemblies where the pivoting connector assembly comprises a pin. In certain embodiments, the longitudinal motion of the pin is constrained by at least one end of the pin engaging with a plastically deformed portion of the contact section of the gripper finger comprising the pivoting connector assembly.

In certain embodiments, the compositions and methods described herein also relate to end-effectors comprising rocker members where the rocker member pivots about the pivoting connector assembly based on the end-effector gripping a microplate assembly such that respective loads received at the proximal gripper surface and the distal gripper surface are balanced.

In certain embodiments, the compositions and methods described herein relate to end-effectors comprising rocker members where the rocker member is provided with a ridge. In certain embodiments, such end-effectors also comprise contact sections where the contact section is provided with a recess facing the ridge. In certain embodiments, the recess is configured to receive the ridge based on the rocker member pivoting about a pivoting connector assembly. In certain embodiments, the ridge comprises a continuous projection on a side of the rocker member opposite each of the proximal gripper surface and the distal gripper surface. In certain embodiments, the ridge comprises a plurality of projections on the rocker member and the contact section comprises a plurality of recesses. In certain embodiments, each recess of the plurality of recesses is respectively configured to receive corresponding projections. In certain embodiments, the recess of the contact section receiving the ridge of the rocker member permits an increased range of maximum rotation of the rocker member about a pivoting connector assembly.

In certain embodiments, the range of maximum rotation of the rocker member about a pivoting connector assembly is between 0.5 degrees and 10 degrees. In certain embodiments, the range of maximum rotation is separately provided for a clockwise rotation or a counter-clockwise rotation from the non-rotated position. In certain embodiments, the range of maximum rotation is between 0.5 degrees and 10 degrees for a clockwise rotation of the rocker member pivoting from the non-rotated position about the pivoting connector assembly. In certain embodiments, the range of maximum rotation between 0.5 degrees and 10 degrees for a counter-clockwise, or anti-clockwise, rotation of the rocker member pivoting from the non-rotated position about the pivoting connector assembly. In certain embodiments, the range of maximum rotation from the non-rotated position is symmetric based on equal respective values of the range of maximum rotation of the rocker member pivoting about the pivoting connector assembly in a clockwise direction of rotation and a counter-clockwise direction of rotation.

In certain embodiments, the compositions and methods described herein relate to end-effectors comprising a transition section connecting a contact section of each gripper finger to the respective attachment end. In certain embodiments, the transition section comprises a portion of reduced cross-sectional area configured to prevent interference of the end-effector, e.g., interference with an instrument or a microplate assembly.

In certain embodiments, the compositions and methods described herein relate to end-effectors where the respective height of each of the proximal, intermediate, and distal gripper surfaces is based on features of the object being engaged. For example, but not by way of limitation, the respective height of each of the proximal, intermediate, and distal gripper surfaces can be based on the gap between a microplate and a microplate lid when the microplate lid is assembled with the microplate.

In certain embodiments, the compositions and methods described herein relate to end-effectors where each of the first and second gripper fingers comprises hardened stainless steel or titanium.

In certain embodiments, the compositions and methods described herein relate to end-effectors where one or more of the interfacing surfaces are disposed on a microplate assembly including a microplate. In certain embodiments, the microplate assembly further comprises a microplate lid.

In certain embodiments, the compositions and methods described herein relate to sample-handling robotic systems. For example, in certain embodiments such sample-handling robotic systems comprise: a memory; a processor in communication with the memory; a robot in communication with the processor and configured to manipulate a plurality of objects, e.g., microplate assemblies, based on communication with the processor. In certain embodiments, the robot comprises: a robot arm operatively connected to the robot and configured to be positioned by the robot; and an end-effector operatively coupled to the robot arm. In certain embodiments, the end-effector comprises: a first gripper finger; and a second gripper finger, the first and second gripper fingers configured to be selectively separable from each other, each of the first gripper finger and the second gripper finger respectively including an extended member having an attachment end and a contact section opposite the attachment end, wherein the first gripper finger further comprises a rocker assembly. In certain of such sample-handling robotic system embodiments the rocker assembly comprises: a rocker member having a proximal portion and a distal portion; a pivoting connector assembly disposed between the proximal portion and the distal portion of the rocker member and configured to pivotally couple the rocker member to the contact section of the first gripper finger; and a proximal gripper surface and a distal gripper surface respectively provided at the proximal portion and the distal portion of the rocker member. In certain of such embodiments, the second gripper finger further comprises an intermediate gripper surface provided at the contact section of the second gripper finger, where the intermediate gripper surface is disposed between parallel planes respectively passing through the proximal gripper surface and the distal gripper surface. In certain of such embodiments, each of the proximal, intermediate, and distal gripper surfaces is configured to cooperatively engage with a respective interfacing surface.

In certain embodiments, the compositions and methods described herein relate to a sample-handling robotic system where at least one gripper surface comprises one or more surface features to facilitate cooperative engagement with the respective interfacing surface. In certain embodiments of such sample-handling robotic systems, each of the surface features converges toward an interfacing surface at a tip or an edge.

In certain embodiments, the compositions and methods described herein relate to a sample-handling robotic system comprising end-effectors where at least one gripper surface comprises a metallic gripper pad or a plastic gripper pad.

In certain embodiments, the compositions and methods described herein relate to a sample-handling robotic system comprising end-effectors where at least one gripper surface comprises a gripper pad made of an elastomeric material capable of deforming under load to facilitate cooperative engagement with the respective interfacing surface.

In certain embodiments, the compositions and methods described herein relate to a sample-handling robotic system comprising end-effectors where the end-effector comprise a pivoting connector assembly that comprises a pin. In certain of such sample-handling robotic systems, longitudinal motion of the pin is constrained by at least one end of the pin engaging with a plastically deformed portion of the contact section.

In certain embodiments, the compositions and methods described herein relate to a sample-handling robotic system comprising end-effectors where the end-effectors comprise rocker members. In certain of such embodiments, the rocker member pivots about a pivoting connector assembly. For example, in certain embodiments, such pivoting is based on the end-effector gripping an object, e.g., a microplate assembly, such that respective loads received at the proximal gripper surface and the distal gripper surface are balanced.

In certain embodiments, the compositions and methods described herein relate to a sample-handling robotic system comprising end-effectors where end-effectors comprise a rocker member. In certain of such embodiments, the rocker member is provided with a ridge. In certain of such embodiments, the contact section is provided with a recess facing the ridge of the rocker member and the recess is configured to receive the ridge based on the rocker member pivoting about the pivoting connector assembly. In certain of such embodiments, the recess of the contact section receiving the ridge of the rocker member permits an increased range of maximum rotation of the rocker member about the pivoting connector assembly.

In certain embodiments, the compositions and methods described herein relate to a sample-handling robotic system comprising end-effectors where the end-effectors comprise a transition section connecting the contact section of each gripper finger to the respective attachment end. In certain of such embodiments, the transition section comprises a portion of reduced cross-sectional area configured to prevent interference of the end-effector with an instrument or other object, e.g., a microplate assembly.

In certain embodiments, the compositions and methods described herein relate to a sample-handling robotic system comprising end-effectors where the respective height of each of the proximal, intermediate, and distal gripper surfaces of the end-effectors is based on features of the object being engaged. For example, but not by way of limitation, the respective height of each of the proximal, intermediate, and distal gripper surfaces can be based on the gap between a microplate and a microplate lid when the microplate lid is assembled with the microplate.

In certain embodiments, the compositions and methods described herein relate to a sample-handling robotic system comprising end-effectors where each of the first and second gripper fingers of the end-effectors comprise hardened stainless steel or titanium.

In certain embodiments, the compositions and methods described herein relate to a sample-handling robotic system comprising end-effectors where one or more of the interfacing surfaces engaged by the end-effectors are disposed on a microplate assembly including a microplate. In certain of such embodiments, the microplate assembly further comprises a microplate lid.

In certain embodiments, a method of operating a robotic system including an end-effector is disclosed, the method including: gripping a microplate assembly by a plurality of gripper surfaces, the plurality of gripper surfaces including a proximal gripper surface and a distal gripper surface provided on a rocker member, the rocker member pivotally coupled to a first gripper finger of the end-effector, the plurality of gripper surfaces further including an intermediate gripper surface coupled to a second gripper finger of the end-effector, the intermediate gripper surface disposed between parallel planes respectively passing through the proximal gripper surface and the distal gripper surface; mechanically aligning the rocker member based on the robotic system gripping the microplate assembly such that respective loads received at the proximal gripper surface and the distal gripper surface of the rocker member are balanced; and operating one or more robot arms of the robotic system to provide one or more positional changes to the microplate assembly, wherein the end-effector is operatively coupled to aa robot arm of the one or more robot arms.

In certain embodiments, a method further includes, prior to gripping the microplate assembly, separating the first gripper finger and the second gripper finger to accommodate the microplate assembly. In certain embodiments, a method, wherein the microplate assembly is gripped by decreasing a separation between the first gripper finger and the second gripper finger such that the microplate assembly is engaged by the plurality of gripper surfaces. In certain embodiments, the one or more positional changes are provided by the one or more robot arms of the robotic system such that a lid is assembled on a microplate or the lid is disassembled from the microplate, the microplate assembly including the lid and the microplate.

In certain embodiments, the one or more positional changes are provided by the one or more robot arms of the robotic system such that the microplate assembly is lowered into a recessed enclosure of an instrument or raised from the recessed enclosure of the instrument, wherein each of the first and second gripper fingers respectively includes an attachment end and a contact section provided opposite the attachment end, the proximal gripper surface and the distal gripper surface disposed at the contact section of the first gripper finger, the intermediate gripper surface disposed at the contact section of the second gripper finger, and wherein the attachment end of each of the first and second gripper fingers is configured to be vertically offset from the respective contact section to facilitate access to the recessed enclosure of the instrument. In certain embodiments, the one or more positional changes are provided by the one or more robot arms of the robotic system such that the microplate assembly is inserted into a recessed enclosure of an instrument or retrieved from the recessed enclosure of the instrument, wherein each of the first and second gripper fingers respectively includes an attachment end and a contact section provided opposite the attachment end, the proximal gripper surface and the distal gripper surface disposed at the contact section of the first gripper finger, the intermediate gripper surface disposed at the contact section of the second gripper finger, and wherein the attachment end of each of the first and second gripper fingers is configured to be horizontally offset from the respective contact section to facilitate access to the recessed enclosure of the instrument.

In certain embodiments, the microplate assembly is gripped by the plurality of gripper surfaces of the robotic system engaging a pair of opposing sides of a microplate, the pair of opposing sides being parallel to a lengthwise axis of the microplate, wherein the lengthwise axis is longer than a widthwise axis of the microplate. In certain embodiments, the microplate assembly is gripped by the plurality of gripper surfaces of the robotic system engaging a pair of opposing sides of a microplate, the pair of opposing sides being parallel to a widthwise axis of the microplate, wherein the widthwise axis is shorter than a lengthwise axis of the microplate. In certain embodiments, at least one gripper surface of the plurality of gripper surfaces gripping the microplate assembly includes one or more surface features to facilitate cooperative engagement with a respective interfacing surface of the microplate assembly, each of the one or more surface features converging toward the microplate assembly at a a tip or an edge. In certain embodiments, at least one gripper surface of the plurality of gripper surfaces gripping the microplate assembly includes a metallic gripper pad or a plastic gripper pad. In certain embodiments, at least one gripper surface of the plurality of gripper surfaces gripping the microplate assembly includes a gripper pad made of an elastomeric material capable of deforming under load to facilitate cooperative engagement with a respective interfacing surface of the microplate assembly.

In certain embodiments, mechanical alignment of the rocker member is facilitated by the rocker member pivoting about a pin, and wherein a longitudinal motion of the pin is constrained by at least one end of the pin engaging with a plastically deformed portion of the first gripper finger.

In certain embodiments, an end-effector for a sample-handling robotic system is disclosed, the end-effector including a first gripper finger; and a second gripper finger, the first and second gripper fingers configured to be selectively separable from each other, each of the first gripper finger and the second gripper finger respectively including an extended member having an attachment end and a contact section opposite the attachment end, the contact section vertically offset from the attachment end, wherein each of the first gripper finger and the second gripper finger further includes a rocker assembly, each rocker assembly respectively including: a rocker member having a proximal portion and a distal portion; a pivoting connector assembly disposed between the proximal portion and the distal portion of the rocker member and configured to pivotally couple the rocker member to the contact section of the respective gripper finger; and a proximal gripper surface and a distal gripper surface respectively provided at the proximal portion and the distal portion of the rocker member, each of the proximal and distal gripper surfaces configured to cooperatively engage with a respective interfacing.

In certain embodiments, at least one gripper surface includes one or more surface features to facilitate cooperative engagement with the respective interfacing surface of a microplate assembly, each of the one or more surface features converging toward the microplate assembly at a tip or an edge. In certain embodiments, the at least one gripper surface includes a metallic gripper pad or a plastic gripper pad. In certain embodiments, at least one gripper surface includes a gripper pad made of an elastomeric material capable of deforming under load to facilitate cooperative engagement with the respective interfacing surface of a microplate assembly. In certain embodiments, each of the pivoting connector assemblies includes a pin, a longitudinal motion of each pin constrained by at least one end of the pin engaging with a plastically deformed portion of the respective contact section. In certain embodiments, each rocker member pivots about the respective pivoting connector assembly based on the end-effector gripping a microplate assembly such that respective loads received at the proximal gripper surface and the distal gripper surface of the respective rocker member are balanced. In certain embodiments, one or more of the interfacing surfaces are disposed on a microplate assembly includes a microplate.

In certain embodiments, the methods described herein relate to the use of any of the above described compositions in connection with the engagement of the end-effector with an instrument or other object, e.g., a microplate assembly. For example, but not by way of limitation, the end-effectors can engage with one or more microplate assemblies to move the assembly through a particular workflow path. In connection with facilitating such movement through a particular workflow path, the end-effectors can engage, translocate, and disengage with one or more instruments and/or other objects and repeat such activity as many times as necessary to achieve the desired outcome.

### BRIEF DESCRIPTION OF THE DRAWINGS

It should be noted that figures provided may be illustrated schematically rather than literally or precisely; components and aspects of the figures may also not necessarily be to scale. Moreover, while like reference numerals may designate corresponding parts throughout the different views in many cases, like parts may not always be provided with like reference numerals in each view.

FIG. 1 illustrates a schematic view of robotic system according to particular embodiments of the present disclosure.

FIG. 2 illustrates a schematic perspective view of an end-effector for a robotic system according to particular embodiments of the present disclosure.

FIGS. 3a-3d illustrate schematic views of examples of microplate assemblies according to particular embodiments of the present disclosure.

FIGS. 4-7 depict schematic perspective views of robotic systems in use with example instruments according to particular embodiments of the present disclosure.

FIGS. 8a-8b illustrate schematic top and partial enlarged views, respectively, of an end-effector having four gripper surfaces according to particular embodiments of the present disclosure.

FIGS. 9a-9b illustrate schematic top and partial enlarged views, respectively, of an end-effector having three gripper surfaces according to particular embodiments of the present disclosure.

FIGS. 10a-10b illustrate schematic views of an end-effector with dissimilar gripper surfaces according to particular embodiments of the present disclosure.

FIGS. 11a-11b illustrate example grip configurations based on schematic views of an end-effector gripping a microplate assembly according to particular embodiments of the present disclosure.

FIGS. 12a-12b illustrate schematic perspective views of a gripper finger of an end-effector according to particular embodiments of the present disclosure.

FIGS. 13a-13b illustrate schematic side views of a gripper finger of an end-effector according to particular embodiments of the present disclosure.

FIGS. 14a-14b illustrate schematic top and front views, respectively, of a gripper finger of an end-effector according to particular embodiments of the present disclosure.

FIG. 14c illustrates a schematic partial enlarged front view of a gripper finger gripping a microplate assembly according to particular embodiments of the present disclosure.

FIGS. 15a-15b illustrate schematic perspective views of a contact section of a gripper finger, with a rocker member assembled in phantom view, and removed, respectively, according to particular embodiments of the present disclosure.

FIGS. 16a-16c illustrate schematic perspective views of a contact section of a gripper finger, with a rocker member assembled in phantom view, opaque view, and with the rocker member isolated, respectively, according to particular embodiments of the present disclosure.

FIG. 16d illustrates a schematic partial enlarged perspective view of the contact section of FIGS. 16a-16c engaged with a gripped object according to particular embodiments of the present disclosure.

FIGS. 17a-17c illustrate schematic partial perspective views of examples of gripper surfaces according to particular embodiments of the present disclosure.

FIGS. 18a-18b illustrate schematic top perspective and bottom perspective views, respectively, of a teaching jig for a robotic system according to particular embodiments of the present disclosure.

FIG. 19 illustrates a schematic side phantom view of a teaching jig gripped by a gripper finger for calibrating an end-effector according to particular embodiments of the present disclosure.

FIG. 20 illustrates a schematic computer system of a robotic system according to particular embodiments of the present disclosure.

### DETAILED DESCRIPTION

The presently disclosed subject matter relates to end-effectors facilitating the interface between robotic systems and a wide variety of interfacing surfaces, e.g., standard microtiter plates and sample preparation workflow instruments, as well robotic systems comprising such end-effectors and methods of using such end-effectors and robotic systems comprising such end-effectors.

For purposes of clarity of disclosure and not by way of limitation, the detailed description is divided into the following subsections:
1. Definitions
2. End-Effector Compositions and Methods of Use
3. End-Effector Teaching Jig
4. Computer System-Controlled End-Effectors
5. Exemplary Embodiments
6. Examples

### 1. Definitions

Unless otherwise defined, all technical and scientific terms used herein have the same meaning as commonly understood by one of ordinary skill in the art. In case of conflict, the present document, including definitions, will control. Exemplary methods and materials are described below, although methods and materials similar or equivalent to those described herein can be used in practice or testing of the presently disclosed subject matter. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other instances “comprising,” “consisting of”, and “consisting essentially of,” the instances or elements presented herein, whether explicitly set forth or not.

For the recitation of numeric ranges herein, each intervening number within the range is explicitly contemplated with the same degree of precision. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

### 2. End-Effector Compositions and Methods of Use

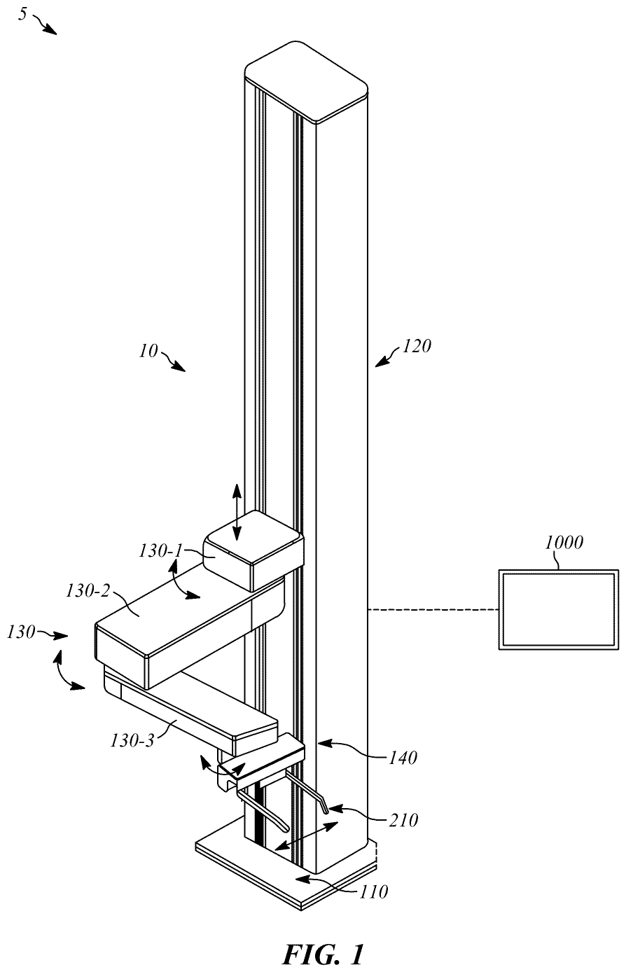

FIG. 1 illustrates a schematic view of a robotic system according to particular embodiments of the present disclosure. An exemplary robotic system 5 can include a robot 10 in communication with a computing system 1000. By way of example and not limitation, robot 10 can comprise a base 110, one or more stages enabling horizontal and/or vertical motion, such as vertical stage 120, one or more robot arms 130 providing additional degrees of freedom and articulation, such as the robot arms 130-1, 130-2, and 130-3 illustrated in FIG. 1 capable of rotating about their respective interconnections, and an end-effector 140 to enable or permit the robot 10 to interact with its task, such as gripping, manipulating, and/or repositioning one or more objects.

In particular embodiments, end-effector 140 can be provided with one or more gripper fingers 210, such as one or more gripper fingers 210-1, 210-2, and so on. End-effector 140 can be coupled to a suitable component of robot 10, such as a robot arm 130. FIG. 1 illustrates an exemplary end-effector 140 coupled to robot arm 130-3, which in turn is shown to be operatively coupled to base 110 of robot 10 by way of robot arms 130-2 and 130-1, and vertical stage 120.

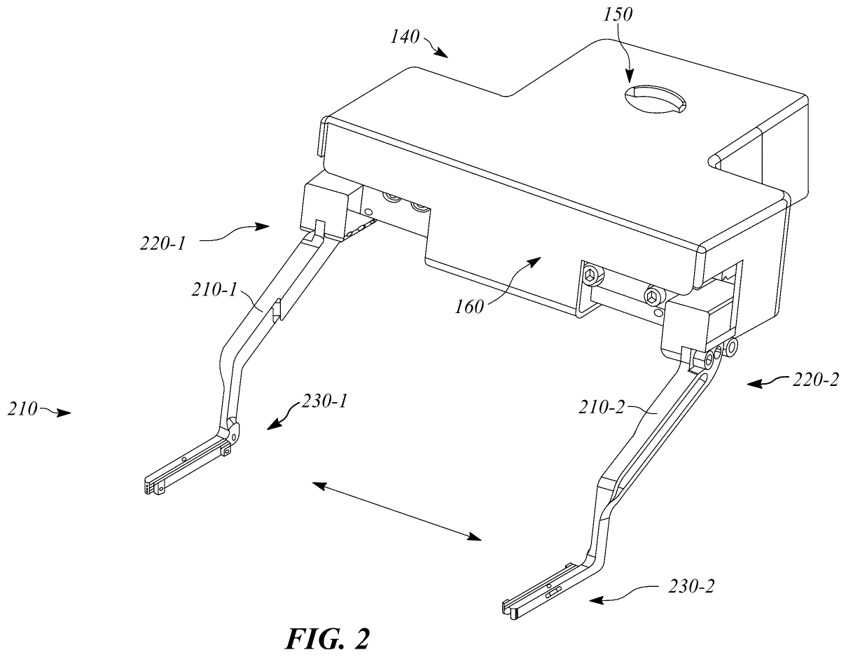

FIG. 2 illustrates a schematic perspective view of an end-effector for a robotic system according to particular embodiments of the present disclosure. In particular embodiments, an arm 130 may be provided with a mounting flange for coupling an end-effector 140 via a suitable interface, such as flange connection 150. In particular embodiments, end-effector 140 can comprise one or more gripper fingers 210, such as one or more gripper fingers 210-1, 210-2, 210-3, and so on. In certain embodiments, the gripper fingers 210 comprise hardened stainless steel, or titanium, or any material or combination of materials suitable for resisting deformation under load based on other constraints described herein. Separately or additionally, suitable materials may require corrosion resistance, such as for operation in particular sample-handling applications and environments. For example, but not by way of limitation the hardened steel can be 17-4 stainless steel. As another non-limiting example, the titanium can be TI-6AI-4V.

By way of example and not limitation, as illustrated in FIG. 2, end-effector 140 can comprise two gripper fingers, such as gripper fingers 210-1 and 210-2, configured to be selectively separable from each other. In particular embodiments, a separation mechanism 160 can be provided in end-effector 140, such as using a rack-and-pinion mechanism, or other suitable actuation mechanism for motion. In particular embodiments, separation mechanism 160 provides selective linear separation between one or more gripper fingers 210-1 and one or more gripper fingers 210-2 based on control provided by and/or in communication with computing system 1000 for interacting with a task of robot 10, such as gripping, manipulating, and/or repositioning one or more objects.

In particular embodiments, gripper finger 210, such as 210-1 and 210-2, may be attached to a base, flange connection, and/or other suitable structural part or body of end-effector 140 via an attachment end 220. By way of example and not limitation, attachment end 220 may be configured to accommodate one or more fasteners or other connection features to couple gripper finger 210 to a suitable structural part or body of end-effector 140. In particular embodiments, a contact section 230 of a gripper finger 210 may be provided at an opposite end or portion of gripper finger 210 from a corresponding attachment end 220.

By way of non-limiting example, FIG. 2 illustrates attachment ends 220-1 and 220-2 of respective gripper finger 210-1 and 210-2, each attachment end provided at an opposite end of the respective contact sections 230-1 and 230-2 of the respective gripper fingers. Each attachment end 220-1 and 220-2 is depicted by way of non-limiting example to couple the respective gripper fingers to a base of end-effector 140, the base also comprising flange connection 150 and separation mechanism 160.

It will be appreciated that while the description and/or illustrations provided indicate particular characteristics to one or more gripper fingers 210-2 or 210-2 or further embodiments, such as orientation (e.g., left, right) or features (e.g., number or type of interfaces or gripper surfaces), no particular attribution of such characteristics to particular gripper fingers 210-1 or 210-2 or further embodiments is intended or limiting.

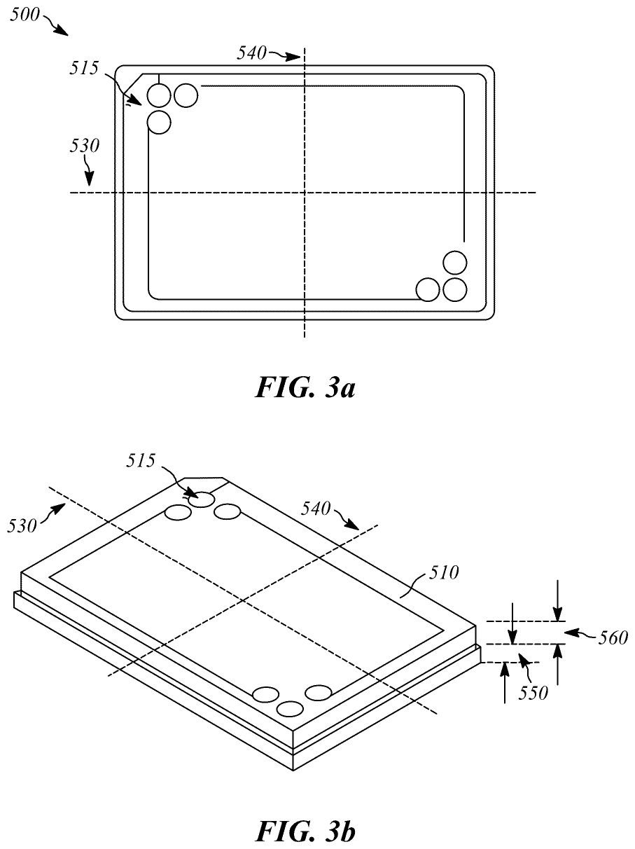

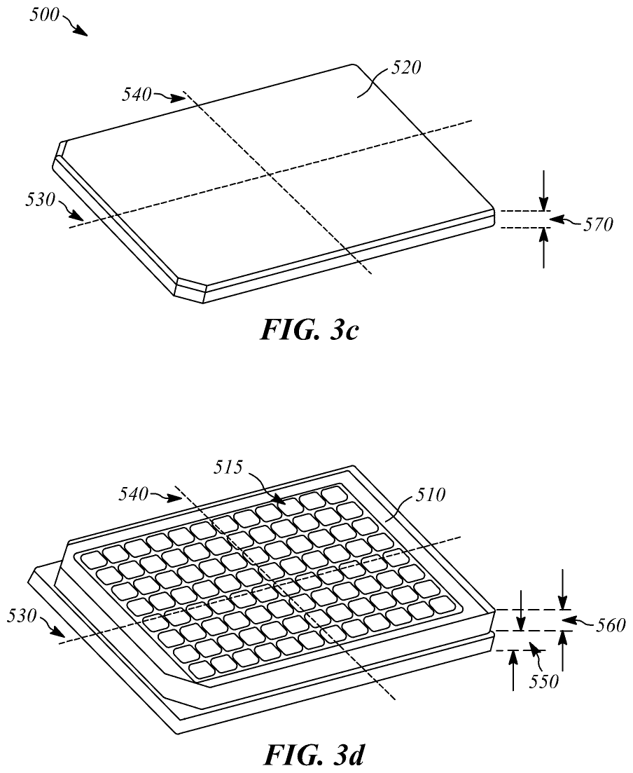

According to particular embodiments of the present disclosure, robot 10 can be used for gripping, manipulating, and/or repositioning a variety of objects, e.g., microplate assemblies, for sample handling. FIGS. 3a-3d illustrate schematic views of examples of microplate assemblies, according to particular embodiments of the present disclosure. FIG. 3a illustrates a schematic top view of a microplate assembly 500 comprising a microplate 510. FIGS. 3b-3d illustrate schematic perspective views of parts of exemplary microplate assemblies 500. Wells 515 of a standardized microplate can vary widely in number, cross-sectional size, depth, shape, and other parameters. In particular embodiments of the present disclosure, a microplate 510 may have non-square proportions, i.e., comprising a longer axis 530 and a shorter axis 540.

In particular embodiments of the present disclosure, a microplate assembly 500 may comprise a microplate lid 520, such as illustrated in FIG. 3c, which can be configured to be removably assembled or fitted over microplate 510. In particular embodiments, a microplate 510 can be provided with a step reduction in an upper cross-sectional area relative to a lower cross-sectional area, such as to accommodate a microplate lid 520 over or surrounding an upper section perimeter. By way of example and not limitation, microplate 510 can have a base height 550 and an upper section height 560. In particular embodiments of the present disclosure, a microplate lid thickness 570 may be less than upper section height 560.

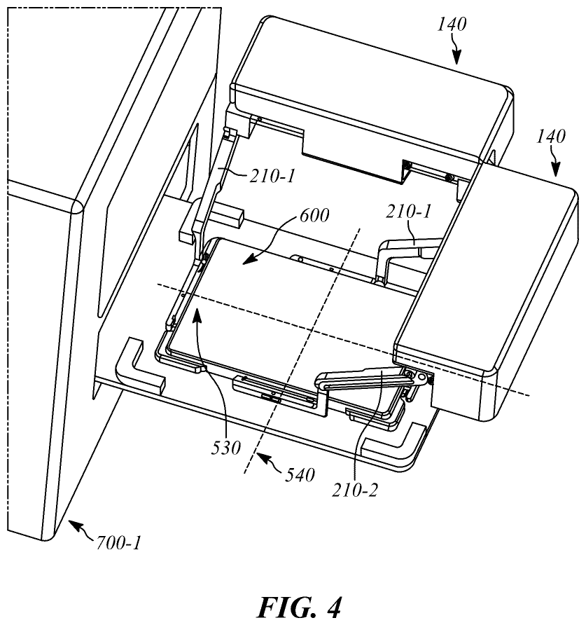

FIGS. 4-7 depict schematic perspective views of robotic systems in use with exemplary instruments according to particular embodiments of the present disclosure. In particular embodiments, a robotic system can be configured for a gripped object 600 to be inserted or loaded into, retrieved or removed from, manipulated in or into position, or otherwise handled or processed with respect to an instrument and/or instrument configuration 700. In each of FIGS. 4-7, use of the end effector 140 in connection with a distinct instrument configuration 700-1, 700-2, 700-3, 700-4, and 700-5 is illustrated, the instrument configurations 700-1 through 700-5 provided herein as non-limiting examples of instrument 700 that robotic system 5, robot 10, and/or end-effector 140 are configured to interface and interoperate with.

In certain instrument configurations, the gripped object 600, can be gripped in portrait or landscape orientation. By way of example and not limitation, FIG. 4 depicts two exemplary orientations of end-effector 140 gripping a gripped object 600, each orientation positioned to manipulate and interact with an exemplary instrument 700-1 in particular ways.

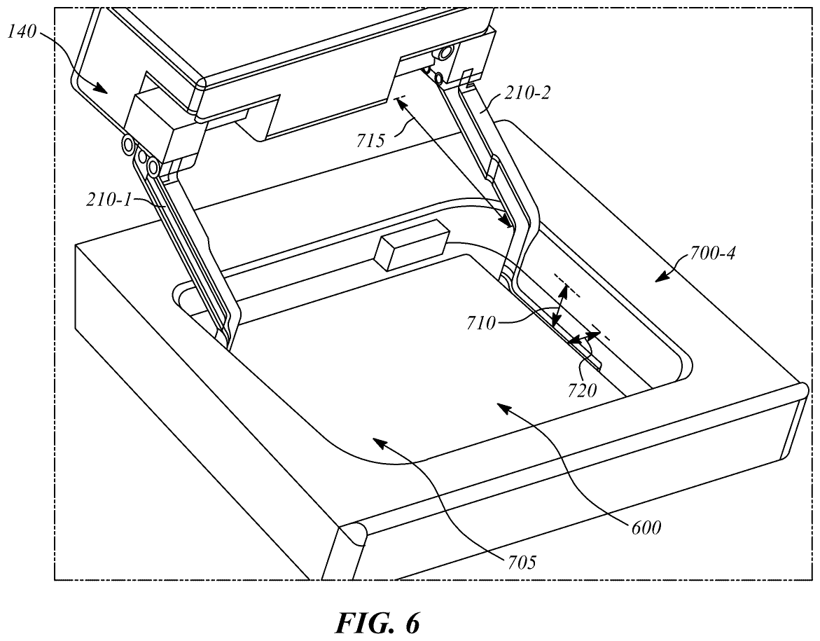

In certain instrument configurations, the gripper fingers 210-1 and 210-2 are employed to place a gripped object 600 on a stage, e.g., FIG. 4 and FIG. 6, or to slide a gripped object 600 into contact with a slot or other receptacle. Without limitation, gripped object 600 can comprise a microplate assembly 500. In particular embodiments, microplate assembly 500 can comprise microplate 510 and microplate lid 520.

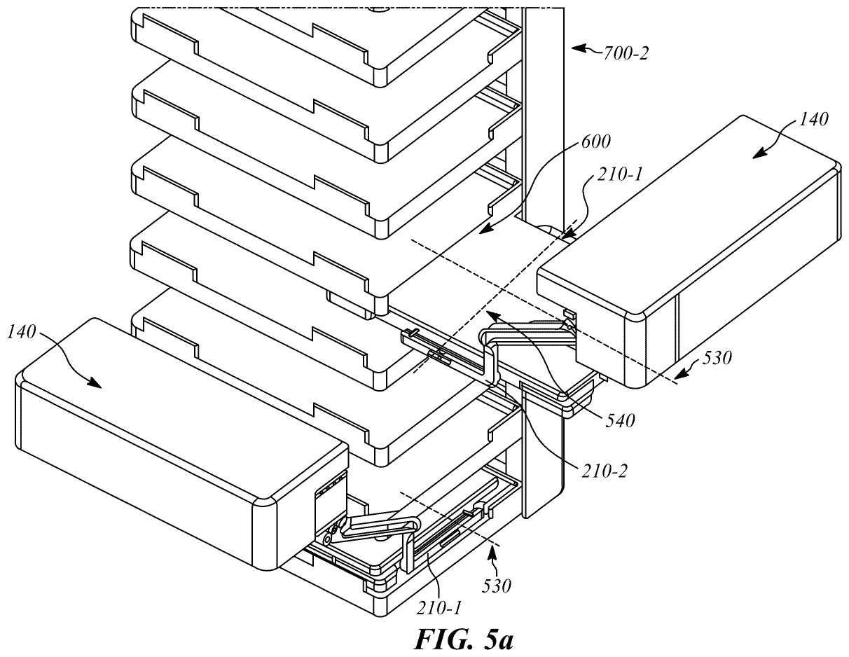

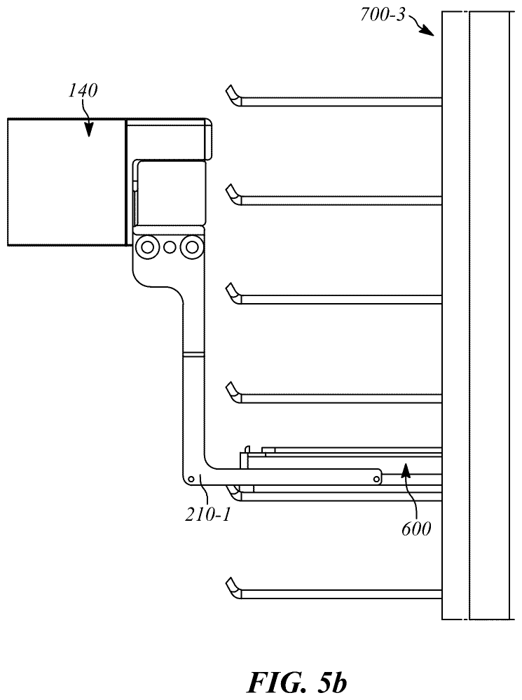

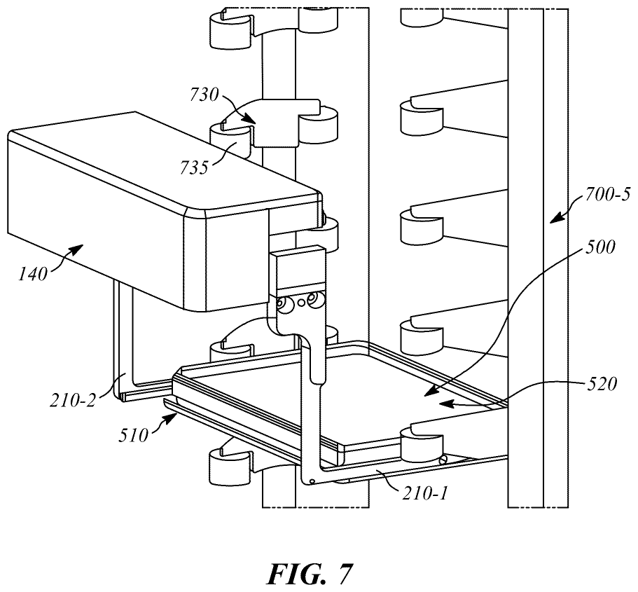

By way of example and not limitation, FIGS. 5a and 5b illustrate interaction of end-effector 140 with racks for storage or retrieval of microplate assembly 500 in portrait or landscape orientations. As a further non-limiting example, FIG. 7 illustrates interaction of end-effector 140 with a de-lidder 730 having rollers 735, such that particular sequences of horizontal and/or vertical motion and positioning of end-effector 140 can permit manipulation of microplate assembly 500, such as assembly and/or disassembly of microplate lid 520 relative 20 to microplate 510.

In particular embodiments, particular features of end-effector 140 can permit interaction of end-effector 140 to access and interoperate with geometric aspects and constraints of instrument 700. By way of example and not limitations, FIG. 6 illustrates the ability of gripper fingers 210-1 and 210-2 operate within the constraints of an exemplary instrument 700-4, such as to access, grip, and remove gripped object 600.

In particular embodiments, an instrument 700, such as 700-4, can include one or more geometric features and aspects, such as one or more of: recessed slots 705 (or elevated platform, not shown), vertical offsets 710, horizontal offsets 715, and/or narrow clearances 720, that can constrain critical dimensions of one or more 210-1 and 210-2 while retaining static and dynamic structural and performance requirements of end-effector 140.

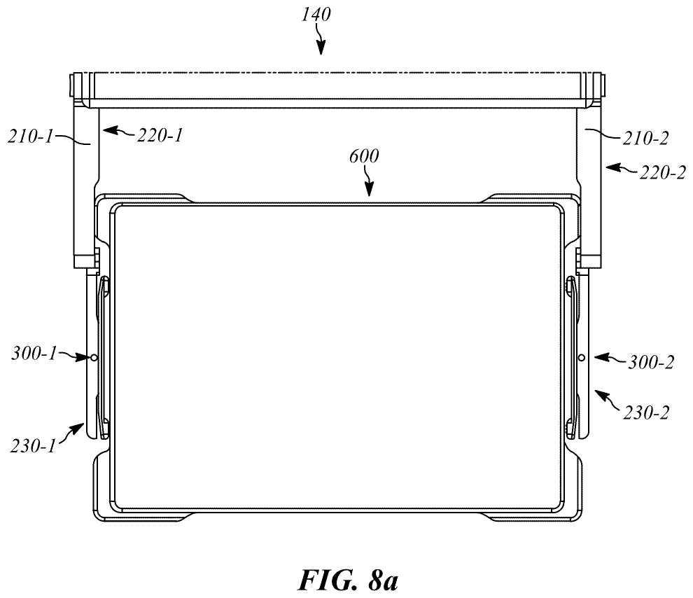

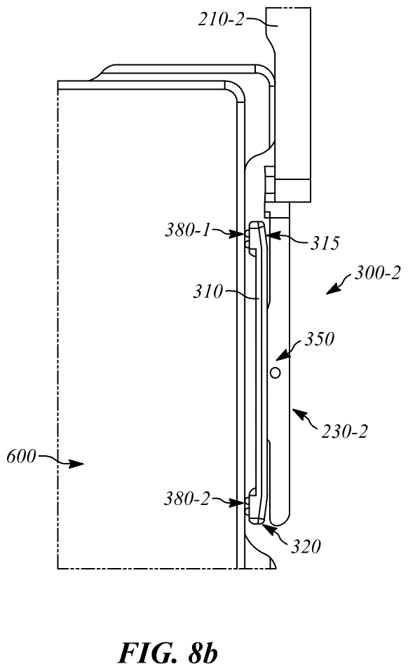

It should be appreciated that the examples of certain embodiments, features, and combinations thereof, of instruments 700 and/or gripped objects 600 are provided to facilitate a better understanding of this disclosure, and not to limit the scope of the disclosure. FIGS. 8a-8b illustrate schematic top and partial enlarged views, respectively, of an end-effector having two gripper fingers (such as 210-1 and 210-2), with each gripper finger comprising a plurality of gripper surfaces according to particular embodiments of the present disclosure. In particular embodiments, end-effector 140 may comprise four gripper surfaces.

It will be appreciated that terms such as “gripper finger” and “gripper surface” may be used herein for representing, without limitation, any suitable aspects or features of end-effector 140 for interfacing with an object (such as gripped object 600), individually or in interoperation with other features and aspects of end-effector 140. Further, gripper surfaces are fully contemplated that comprise a point, line, or area contact interface, and/or any other suitable physical form or combination of interfaces.

Particular embodiments of end-effector 140 and gripper fingers thereof must satisfy often conflicting requirements for gripper fingers, such as, by way of non-limiting examples: (a) dimensional limitations to permit or enable access, gripping, and/or other operations of end-effector 140 in light of features and constraints of instruments and/or gripped objects, such as one or more offsets, recesses, gaps, clearances (e.g., 710 and 720 in FIG. 6), form factors and aspect ratios, and/or preferred gripping zones (e.g., to avoid gripping over a barcode or other indication applied on a gripped object 600); (b) material properties and overall design to prevent, or successfully operate despite, flexing or deformation of gripper fingers based on loading and gripping configuration; (c) material properties and overall design to withstand collisions or crashes based on unintended motion and/or contact of end-effector 140; (d) material properties and overall design for reliability, including holding tight tolerances and/or permitting and maintaining consistent operation over thousands of operating cycles; (e) design for precise and smooth operation in light of dynamic loads, such as based on weights, loads, and gripping configurations, distances covered between instruments, desired throughputs, and/or unintentional collisions; (f) variations of surface finish and material of gripped surfaces of gripped object 600. In particular embodiments, specific features and configurations of end-effector 140 and gripper fingers 210, such as including the use of one or more rocker assemblies 300, can enable or permit end-effector 140 to meet some or all of the above requirements in particular applications.

By way of example and not limitation, removal of material to satisfy geometric constraints and/or provide wider operating parameters (e.g., range of maximum rotation of a rocker member) for end effector systems and components can increase undesired deformation and flexing, and/or reduce operational accuracy and repeatability.

According to particular embodiments, one or more of gripper fingers 210 associated with end-effector 140 can comprise a rocker assembly 300. By way of example and not limitation, gripper fingers 210-1 and 210-2 can respectively comprise rocker assemblies 300-1 and 300-2. According to particular embodiments, a rocker assembly 300 (such as 300-2) can comprise a rocker member 310 having a proximal portion 315 and a distal portion 320. Without limitation, proximal portion 315 can be provided with a proximal gripper surface 380-1; separately or additionally, distal portion 320 can be provided with a distal gripper surface 380-2.

In particular embodiments, rocker member 310 configured as disclosed herein can permit end-effector 140 to mitigate or overcome an incorrect approach angle of one or more gripper fingers 210 relative to a gripped object 600. Separately or additionally, in particular embodiments, rocker member 310 configured as disclosed herein can permit end-effector 140 can permit end-effector 140 to mitigate or overcome non-squareness and/or other geometric and material variabilities of gripped object 600 relative to end-effector 140.

In particular embodiments, rocker assembly 300 may comprise a connector assembly, such as a pivoting connector assembly 350, for operatively coupling rocker member 310 to a respective contact section 230 of gripper finger 210. By way of example and not limitation, pivoting connector assembly 350 can be disposed between proximal portion 315 and distal portion 320 of rocker member 310, and can be configured to pivotally couple rocker member 310 to a gripper finger (e.g., 210-2 in FIG. 8b), such as at the corresponding contact section 230 (e.g., 230-2 in FIG. 8b).

According to particular embodiments, pivoting connector assembly 350 may enable or permit rocker member 310 to pivot about pivoting connector assembly 350 such that respective loads experienced by rocker member 310 based on gripping or otherwise interfacing with a gripped object 600 are balanced. Without limitation, loads experienced by rocker member 310 at gripper surfaces 380-1 and 380-2 and/or at pivoting connector assembly 350 may be based on applied and reaction forces, and/or moments about pivoting connector assembly 350.

By way of example and not limitations, in certain embodiments, an end-effector 140 of the present disclosure will engage with a gripped object 600 via four gripper surfaces (e.g., shown in partial view in FIG. 8b as 380-1 and 380-2 in association with the contact section 230-2 of the gripper finger 210-2), but one of skill would understand based on the full view in FIG. 8a that a complementary set of gripper surfaces would engage the gripped object 600 in association with contact section 230-1 of gripper finger 210-1. In certain embodiments, the gripper surfaces, e.g., 380-1 and 380-2, are positioned at the proximal portion 315 of the rocker member 310 and the distal portion 320 of the rocker member 310. In certain embodiments, the pivoting connector assembly 350 allows for pivoting, e.g., around a pin 360, to facilitate engagement of the gripped object 600 by the gripping surfaces, e.g., 380-1 and 380-2. In certain embodiments the displacement is up to about 0.75 mm as the rocker member pivots when the gripper is engaged in a 23 N squeeze force. In certain embodiments, the range of displacement is designed into the gripper finger to meet or exceed expected finger flex, such as based on a +/−4° flex of a gripper finger and/or a contact section from a parallel or square position.

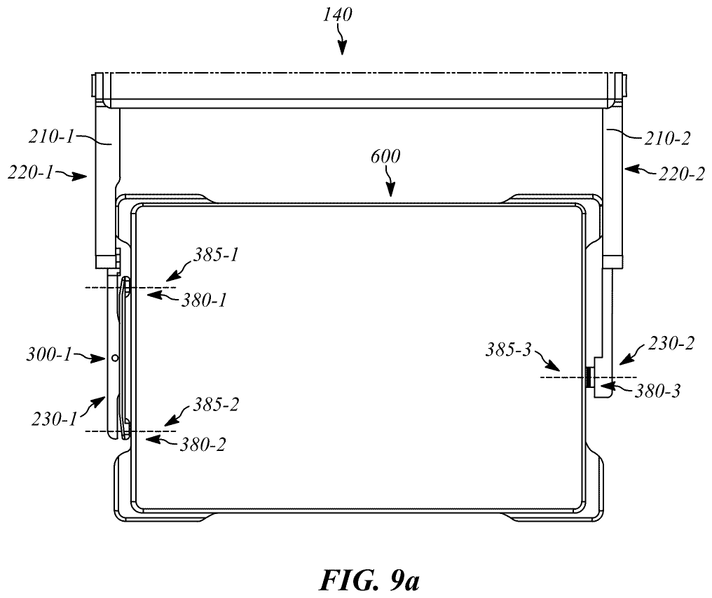

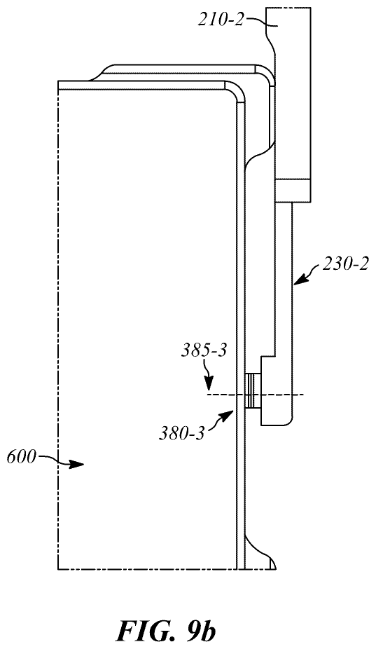

In particular embodiments, end-effector 140 can comprise a plurality of dissimilar gripper fingers 210. FIGS. 9a-9b illustrate schematic top and partial enlarged views, respectively, of an end-effector having three gripper surfaces according to particular embodiments of the present disclosure. By way of example and not limitation, one gripper finger, such as 210-1, of a pair of gripper finger 210-1 and 210-2 may be provided with two gripper surfaces, such as 380-1 and 380-2. Another gripper finger, such as a second gripper finger 210-2 of the pair of gripper fingers 210-2 and 210-2, may be provided with a different number and/or type of gripper surfaces, such as an intermediate gripper surface 380-3 at a corresponding contact section 230-2. In particular embodiments, intermediate gripper surface 380-3 may be disposed at a plane 385-3 disposed between parallel planes 385-1 and 385-2 respectively passing through proximal gripper surface 380-1 and distal gripper surface 380-2, respectively.

In certain embodiments, an end-effector 140 of the present disclosure will engage with a gripped object 600 via three gripper surfaces. As illustrated in FIG. 9a, one gripper finger 210-1 will engage with the gripped object as illustrated in FIGS. 8a and 8b. The third gripper surface 380-3, however, can grip the gripped object 600 as shown in partial view in FIG. 9b. For example, but not by way of limitation, an intermediate gripper surface 380-3, in association with the contact section 230-2 of the gripper finger 210-2, can engage the gripped object 600 at an intermediate plane of the gripped object.

In particular applications, such as gripping and other operations by end-effector 140 relating to a gripped object 600, such as microplate assembly 500, a total set of three interfacing gripping surfaces 380 can provide benefits of optimal kinematic constraint, so that excessive force application, stresses, and/or deformations may be avoided, and optimal grip, grip forces, grip stability of grip, and motion control can be enabled or permitted.

While particular combinations of numbers, types, and/or other configurations of gripper surfaces for a given end-effector 140 may be particularly shown for illustration herein to facilitate a better understanding of the disclosure, any suitable combination(s) of numbers, types, and/or other configurations of gripper surfaces and other relevant parts are fully contemplated in this disclosure.

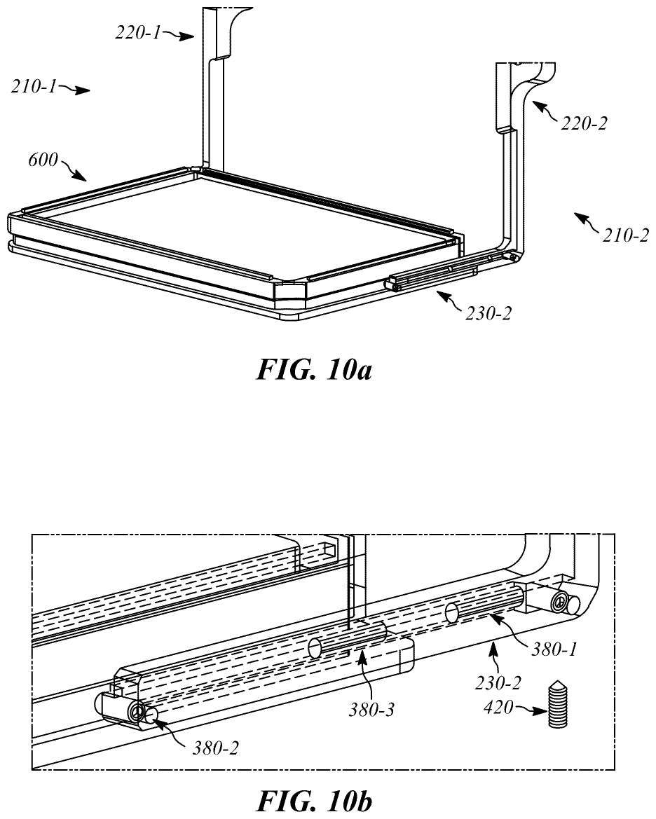

FIGS. 10a-10b illustrate schematic views of an end-effector with dissimilar gripper surfaces according to particular embodiments of the present disclosure. By way of example and not limitation, end-effector 140 can comprise a pair of gripper finger 210-1 and 210-2, with one or both of the each gripper finger comprising more than one or two gripper surfaces 380, such as three gripper surfaces 380-1, 380-2, and 380-3, as illustrated by way of non-limiting example. Separately or additionally, in certain embodiments, a plurality of gripper surfaces provided on a given gripper finger, such as the gripper surfaces 380-1, 380-2, and 380-3 can be the same or different. For example, as illustrated in FIG. 10b, the proximal gripper surface 380-1 and the intermediate gripper surface 380-3 can be similarly positioned with respect to the contact section 230-2 of the gripper finger, while the distal gripper surface 380-2 can be positioned perpendicular to the other gripper surfaces. Alternative arrangements of gripper surfaces 380-1, 380-2, and 380-3 relative to each other and/or relative to the contact section 230-2 of the gripper finger are expressly contemplated as within the scope of the instant disclosure.

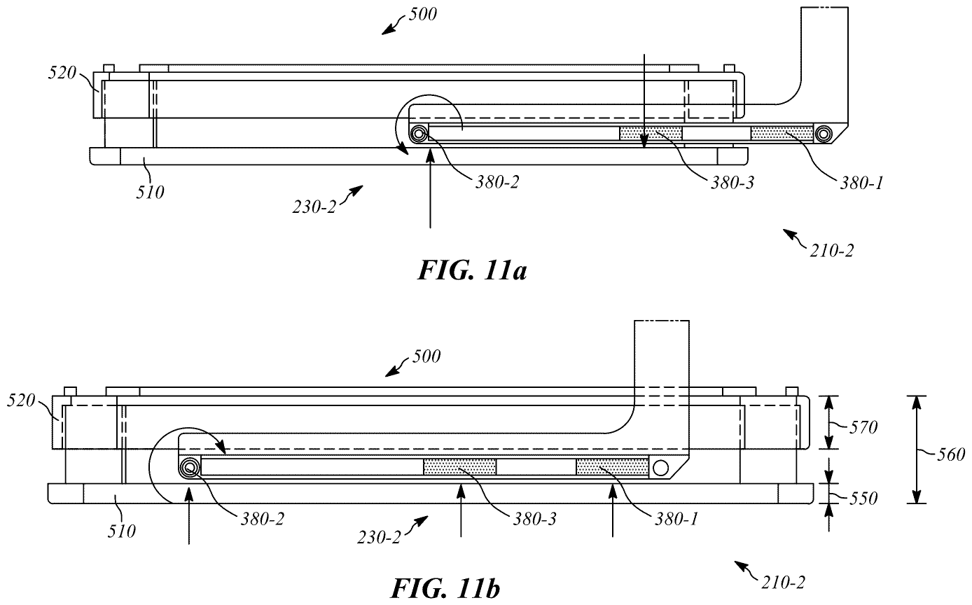

Without limitation, one type of gripper surface 380 can comprise a gripper pad made of a suitable material capable of deforming under load, such as an elastomeric material, to better grip, connect with, or otherwise facilitate cooperative engagement with a respective interfacing surfacing, for example, of a gripped object 600. In the non-limiting example illustrated in FIGS. 10a-10b and 11a-11b, proximal gripper surface 380-1 and intermediate gripper surface 380-3 can comprise this type of gripper surface.

By way of example and not limitation, another type of gripper surface 380 can comprise one or more surface features to better grip, connect with, or otherwise facilitate cooperative engagement with an interfacing surface. In particular embodiments, each of, or a combination of, gripper surface features may converge toward the respective interfacing surface at a tip, or an edge, such that a point-like or line-like contact with the respective interfacing surface may be produced. In the non-limiting examples illustrated in FIGS. 10a-10b and/or 11a-11b, distal gripper surface 380-2 are provided with this type of gripper surface, comprising herein an exemplary cone-point set screw 420 ensuring a single point contact of distal gripper surface 380-2 with a corresponding interfacing surface of gripped object 600.

In particular embodiments, gripper surface 380 can comprise materials or gripper pads made of materials such as metals, non-metals, ceramics, plastics, and/or any suitable materials or combinations for the intended application and design. In particular embodiments, a suitable material for gripper surface 380 may be corrosion resistant, such as for operating in particular sample-handling environments and applications.

FIGS. 11a-11b illustrate example grip configurations based on schematic views of an end-effector gripping a microplate assembly according to particular embodiments of the present disclosure. In certain embodiments the microplate assembly 500 can comprise a microplate 510 and a microplate lid 520. In certain embodiments the microplate assembly will be engaged by the gripper surfaces, e.g., 380-1, 380-2, and/or 380-3, of the rocker member fastened to the contact section 230-2 of the gripper finger.

By way of example and not limitation, as illustrated in FIGS. 11a-11b, a contact section 230-2 of gripper finger 210-2 can be provided with three gripper surfaces 380, i.e., a proximal gripper surface 380-1, a intermediate gripper surface 380-3, and a distal gripper surface 380-2. In particular embodiments and/or operational configurations, a subset of the total number of gripper surfaces 380, such as distal gripper surface 380-2 and intermediate gripper surface 380-3, may be used for gripping a gripped object 600, such as microplate assembly 500.

In the non-limiting example illustrated in FIG. 11a, based on at least a weight of microplate assembly 500 and the relatively proximal gripping location as illustrated, a moment may be generated about distal gripper surface 380-2 (provided herein in the form of a cone-point set screw 420) as indicated by the rotation. Accordingly, distal gripper surface 380-2 and intermediate gripper surface 380-3 in contact with microplate assembly 500 can generate reactions (indicated by the arrows) to provide force and/or moment equilibria to successfully grip microplate assembly 500.

As illustrated in FIG. 11b, when a different set or subset of gripper surface 380 (such as a full set of all gripper surfaces, as a non-limiting example) are used for gripping a gripped object 600 (e.g., a microplate assembly 500), a different load pattern may become relevant. By way of example and not limitation, relative to FIG. 11a and based on a relatively more central, distal, and/or distributed gripping pattern, FIG. 11b depicts an opposite sense or direction of a moment generated about distal gripper surface 380-2. Based on the non-limiting example illustrated in FIG. 11b, such an opposite sense or direction may be based on at least a weight of microplate assembly 500, with each of the three available gripper surface interfaces contributing to balance the weight of microplate assembly 500, and the intermediate gripper surface 380-3 and proximal gripper surface 380-1 providing respective opposing forces to balance the moment based on their respective distances from the cone-point set screw 420 of distal gripper surface 380-2.

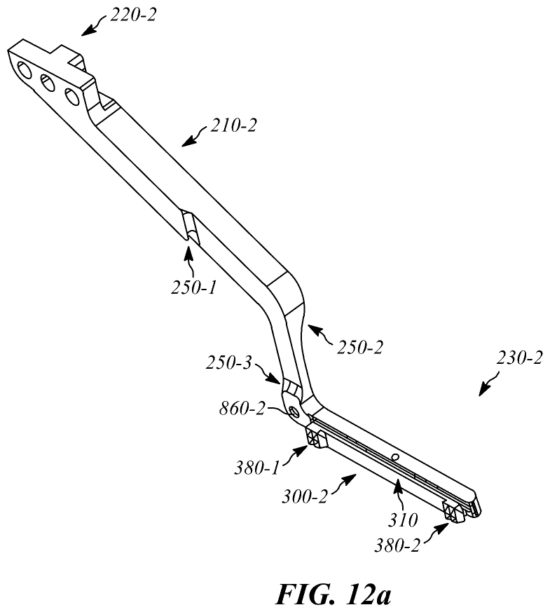

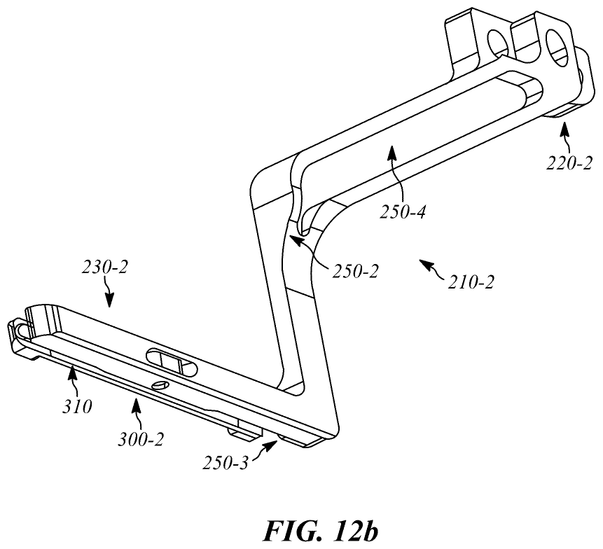

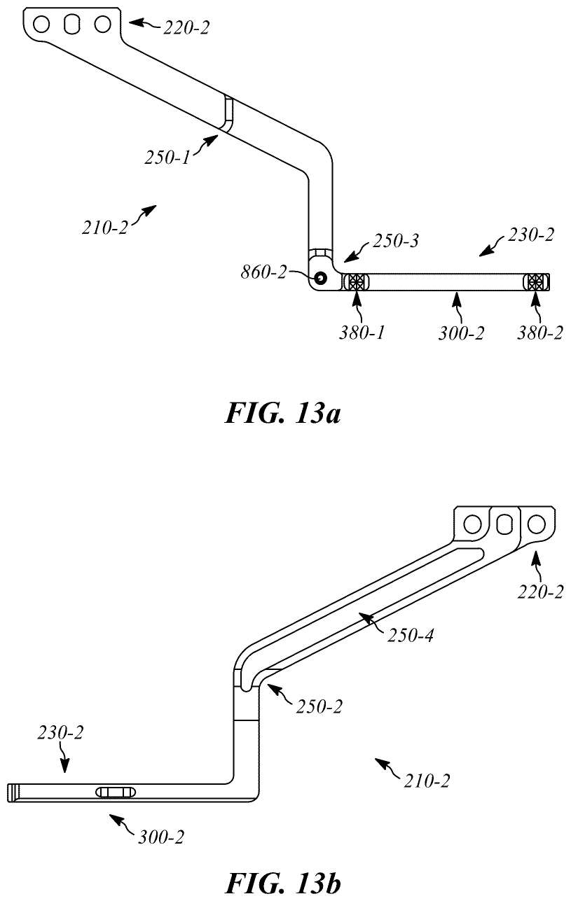

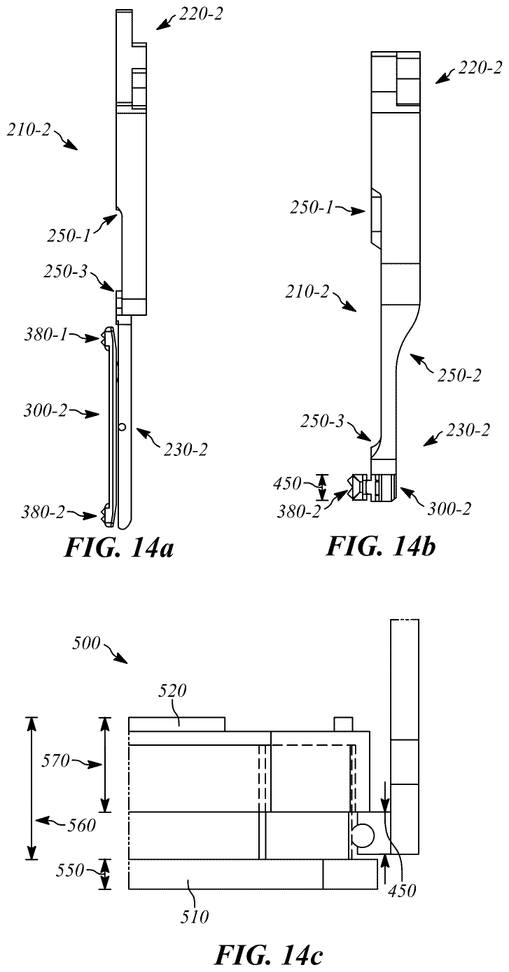

FIGS. 12a-12b illustrate schematic perspective views of a gripper finger of an end-effector according to particular embodiments of the present disclosure. FIGS. 13a-13b illustrate schematic side views of a gripper finger of an end-effector according to particular embodiments of the present disclosure. FIGS. 14a-14b illustrate schematic top and front views, respectively, of a gripper finger of an end-effector according to particular embodiments of the present disclosure.

In particular embodiments, a gripper finger 210 can comprise one or more transition sections 250 connecting the attachment end 220 of gripper finger 210 with the contact section 230. For example, in certain embodiments, the gripper finger 210-2 can comprise an attachment end 220-2 as well as one or more jogged features, e.g., the features in one or more dimensions of transition sections 250 identified as 250-1, 250-2, and 250-3 in FIG. 12a. In particular embodiments, one or more transition sections 250 can comprise a portion of reduced cross-sectional area and/or reduced mass. By way of example and not limitation, as illustrated in FIGS. 12a-12b, a gripper finger 210-2 can comprise one or more transition sections 250, such as transition sections 250-1, 250-2, 250-3, and/or 250-4 (illustrated in at least FIGS. 12b and 13b).

Without limitation, one or more transition sections 250 may comprise a reduced cross-sectional area, curvature, and/or geometric changes in one or more spatial dimensions such that the gripper finger 210 can operate without interfering with instruments 700 and/or gripped objects 600. Separately or additionally, one or more transition sections 250 can enable or permit a reduction of mass and/or improved distribution of mass of gripper finger 210, inherently by reducing a cross-sectional area and/or by other lightweighting, such that dynamic performance of end-effector 140 and/or robot 10 can be improved.

By way of example and not limitation, lightweighting may comprise removal of material, substitution of material, and/or other design optimizations. Without limitation, reducing mass and/or improving mass distribution as disclosed may enable or permit smoother acceleration (positive or negative, and including directional changes), reduced vibration, judder, or overshoots. Reducing mass and/or improving mass distribution as disclosed may enable or permit higher precision, repeatability and/or accuracy of motion of end-effector 140 and/or robot 10.

It will be appreciated that while specific examples of improving mass and mass distribution are provided herein for providing a better understanding of the disclosure, any suitable methods and features for improving mass and mass distribution are contemplated in this disclosure.

In particular embodiments, gripper finger 210-2 can comprise one or more indexing features, such as indexing hole 860-2. By way of example and not limitation, an indexing feature such as indexing hole 860-2 may be used for calibration, such as in conjunction with a teaching jig 800. FIG. 14c illustrates a schematic partial enlarged front view of a gripper finger gripping a microplate assembly according to particular embodiments of the present disclosure. In certain embodiments a gripper surface height 450 of one or more gripper surfaces may be configured such that gripper surface height 450 can engage a microplate assembly 500 and/or microplate 510 when microplate assembly 500 includes a microplate lid 520 assembled with a microplate 510. As previously disclosed and illustrated, a microplate lid thickness 570 of microplate lid 520 may be less than a upper section height 560 or other corresponding dimension of microplate 510. Accordingly, in particular embodiments, a gripper surface height 450 can be configured such that end-effector 140 can access and engage microplate assembly 500 or microplate 510 based on the difference of upper section height 560 and a microplate lid thickness 570, as illustrated by way of non-limiting example.

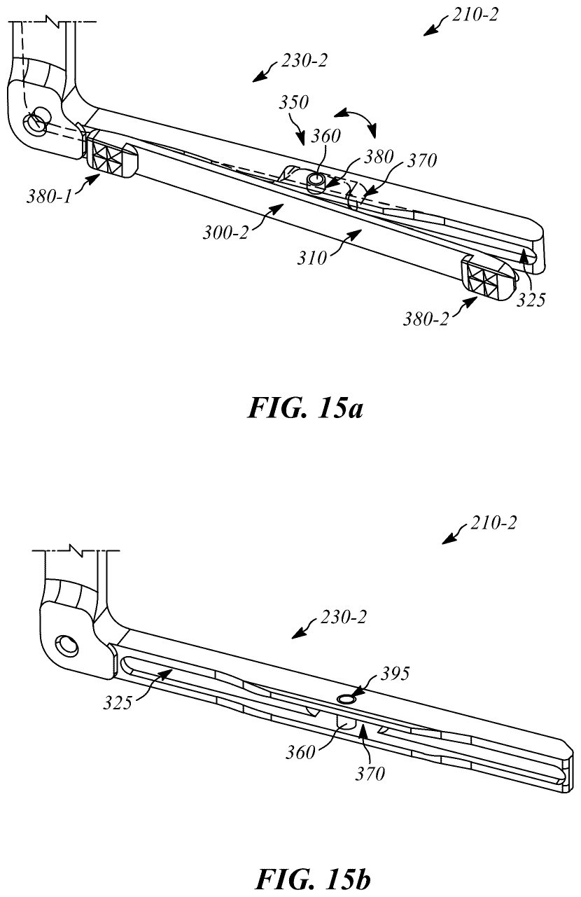

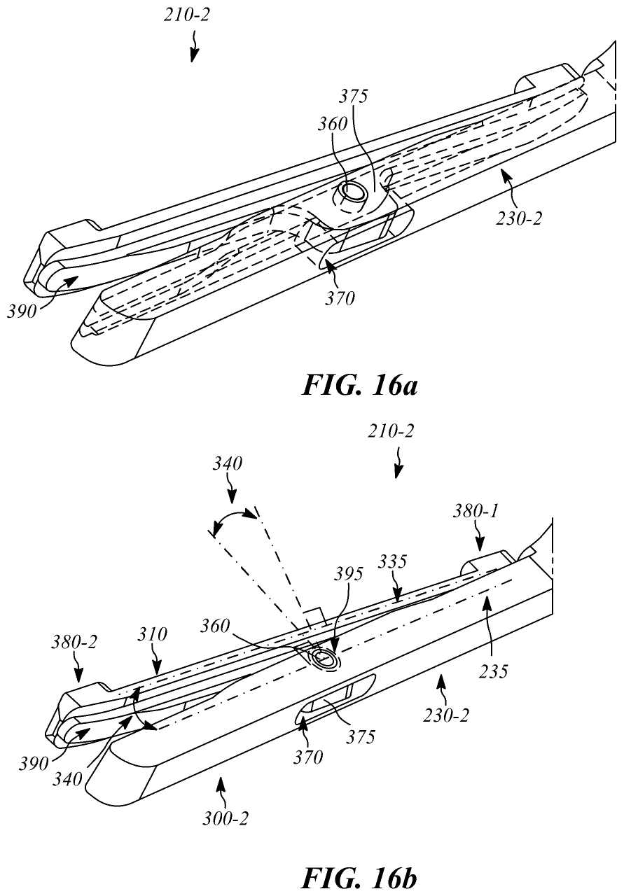

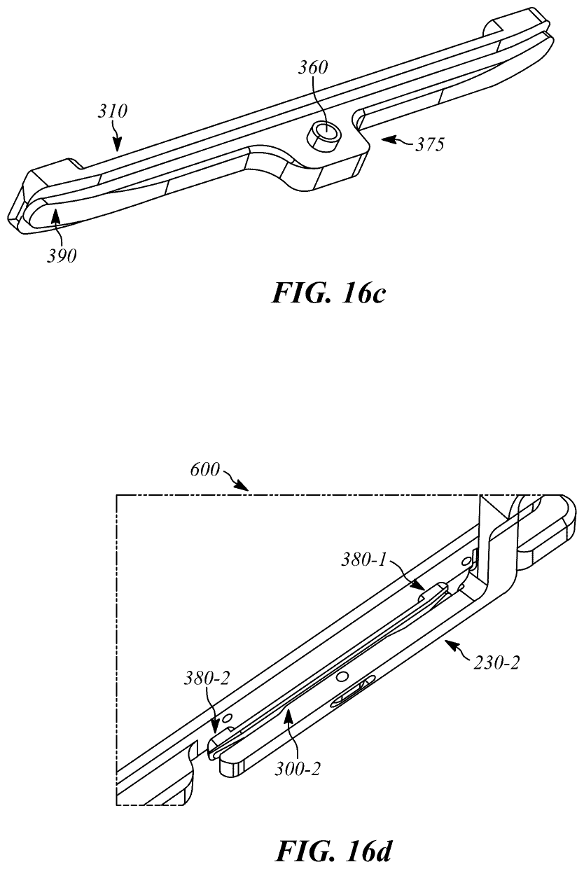

FIGS. 15a-15b illustrate schematic perspective views of a contact section of a gripper finger with a rocker member assembled in phantom view, and removed, respectively, according to particular embodiments of the present disclosure. FIGS. 16a-16c illustrate schematic perspective views of a contact section of a gripper finger, with a rocker member assembled in phantom view, opaque view, and with the rocker member isolated, respectively, according to particular embodiments of the present disclosure.

As illustrated by way of non-limiting example in FIG. 15a, a rocker assembly, such as rocker assembly 300-2, can comprise a rocker member 310 and a pivoting connector assembly 350. In particular embodiments, rocker member 310 can be pivotally coupled to a corresponding gripper finger, such as at contact section 230-2 of gripper finger 210-2 by a pin 360 of pivoting connector assembly 350, and/or by other suitable mechanism.

As previously disclosed herein, in particular embodiments, rocker member 310 can pivot about the pivoting connector assembly 350 such that respective loads at one or more gripper surfaces are balanced. In particular embodiments, one or more loads may be based on end-effector 140 gripping a gripped object 600, such as a microplate assembly 500.

A range of motion of rocker member 310 relative to a gripper finger, such as contact section 230-2 of gripper finger 210-2, can enable or permit linear and/or rotational displacement such as can permit balancing loads at one or more gripper surfaces such that end-effector 140 can securely grip a gripped object 600, and/or perform desired operations based on gripping gripped object 600. As illustrated in FIG. 16b by way of non-limiting example, rocker member 310 can be permitted to pivot about pivoting connector assembly 350 through a non-zero angle of rotation 340. In particular embodiments, angle of rotation 340 can be defined between a contact section longitudinal direction 235 and a rocker member longitudinal direction 335, such as illustrated in FIG. 16b by way of non-limiting example.

In particular embodiments, contact section longitudinal direction 235 may be coincident or parallel to a longitudinal axis of contact section 230, such as 230-3. In particular embodiments, rocker member longitudinal direction 335 may be coincident or parallel to a longitudinal axis of rocker member 310.

Alternatively or similarly, angle of rotation 340 can be defined between the respective perpendicular directions of a rocker member and a corresponding contact section, as also illustrated in FIG. 16b by way of non-limiting example. In particular embodiments, without limitation, a 0° position of angle of rotation 340 can be considered a non-rotated position. In particular embodiments, a neutral position of a rocker member relative to a corresponding gripper finger or corresponding contact section may be considered a non-rotated position. In particular embodiments, a parallel position of a rocker member relative to a corresponding gripper finger or corresponding contact section may be considered a non-rotated position.

In particular embodiments, a range of angle of rotation 340 of rocker member 310 can be 0.5° on either or both sides of a non-rotated position, i.e., measured in either a clockwise direction relative to a non-rotated position, or a counter-clockwise direction relative to a non-rotated position, or both clockwise and counter-clockwise directions relative to a non-rotated position of rocker member 310. In particular embodiments, a range of angle of rotation 340 can be 10° on either or both sides of a non-rotated position. In particular embodiments, a range of angle of rotation 340 can be between 0.5° and 10° on either or both sides of a non-rotated position.

In particular embodiments, a range of angle of rotation 340 can lie between 2° and 7° on either or both sides of a non-rotated position. In particular embodiments, a range of angle of rotation 340 can be ±4° on either or both sides of a non-rotated position.

In particular embodiments, a range of angle of rotation 340 can be symmetric on both sides of a non-rotated position. By way of example and not limitation, for a symmetric range of angle of rotation 340 of 5° relative to a non-rotated position, rocker member 310 may be configured to rotate clockwise through or by a maximum angle of 5° from the non-rotated position, and an equal maximum counter-clockwise angle of 5° from the non-rotated position, with all intermediate values of angle of rotation 340 fully contemplated.

In particular embodiments, a range of angle of rotation 340 can be asymmetric about a non-rotated position. By way of example and not limitation, for an asymmetric range of angle of rotation 340, rocker member 310 may be configured to rotate clockwise through or by a particular maximum angle (e.g., 4°) from a non-rotated position, and a different maximum counter-clockwise angle (e.g., 8°) from the non-rotated position, with all intermediate values of angle of rotation 340 fully contemplated.

In particular embodiments, a minimum designed range of angle of rotation 340, such as 0.5° on either or both sides of a non-rotated position, may be influenced by a rigidity and/or compliance of one or more parts of end-effector 140, which may be based on material selection and/or other design aspects. By way of example and not limitation, a compliance level of a gripper material may influence a choice of a range of angle of rotation 340 designed in an embodiment.

It will be appreciated that while particular exemplary ranges of angle of rotation 340 are specifically included herein, any suitable symmetric and/or asymmetric range of angle of rotation 340 is fully contemplated herein.

In particular embodiments, a range of angle of rotation 340 can be considered synonymous with a range of maximum rotation of rocker member 310, and/or with a rotational range of rocker member 310.

In particular embodiments, a portion of a gripper finger, such as contact section 230-2 of gripper finger 210-2, can be provided with a feature, such as slot 370, to receive a corresponding protrusion of a rocker assembly, such as extension 375. In particular embodiments, extension 375 may be integral to rocker member 310. In particular embodiments, as illustrated by way of non-limiting example in FIGS. 16a-16b, slot 370 may be a through-slot, i.e., open to both sides of a corresponding contact section 230 when rocker assembly 300 is disassembled. In particular embodiments, one or both of slot 370 and extension 375 may be curved or profiled to permit smoother rotation of rocker member 310 about pivoting connector assembly 350, and/or a larger possible range of angle of rotation 340.

In particular embodiments, gripper finger may comprise a protrusion, or similar extending feature, and the rocker assembly may comprise a slot, or similar receiving feature, such that the relative locations of slot 370 and extension 375 can be reversed relative to other embodiments.

In certain embodiments, the contact section can separately or additionally comprise a lengthwise recess, such as recess 325, for receiving a corresponding lengthwise protrusion, such as ridge 390, provided on a rocker member 310. In particular embodiments, recess 325 can configured to receive the ridge 390 based on the rocker member 310 pivoting about the pivoting connector assembly 350.

In particular embodiments, a recess 325 provided for receiving a corresponding ridge 390 of the rocker member 310 can permit or enable an increased range of maximum rotation of the rocker member 310 about the pivoting connector assembly 350, and/or a reduced size, cross-sectional area, and/or other dimensional requirement of a corresponding gripper finger.

In particular embodiments, ridge 390 can comprise a continuous projection on a side of the rocker member 310 opposite each of the corresponding proximal and/or distal gripper surfaces of the rocker member 310. In particular embodiments, ridge 390 can comprise a plurality of projections on the rocker member, and the contact section can comprise a continuous recess, or a plurality of recesses wherein each recess of the plurality of recesses is respectively configured to receive corresponding ones of the plurality of projections of ridge 390.

In particular embodiments, pin 360 can be constrained or captured within or by a portion or component of the corresponding gripper finger, such as gripper finger 210-2. By way of example and not limitation, a longitudinal motion of pin 360 in its assembled location, such as illustrated in FIGS. 15a-15b, can be constrained by peening pin 360 in place, or by one or more suitable processes. In particular embodiments, one or the other of pin 360 and the corresponding gripper finger, such as contact section 230-2 of gripper finger 210-2, may be mechanically deformed to capture pin 360 in place along particular dimensions, such as longitudinally. In particular embodiments, pin 360 can be captured or constrained in place by a suitable process, such as peening, for the life of the component and/or overall assembly of end-effector 140.

In particular embodiments, peening, or another suitable process, can include plastically deforming one or more portions of the corresponding gripper finger, such as contact section 230-2 of gripper finger 210-2. FIGS. 15b and 16b illustrate a plastically deformed portion 395 of contact section 230-2 of gripper finger 210-2, by way of non-limiting example.

FIG. 16d illustrates a schematic partial enlarged perspective view of the contact section of FIGS. 16a-16c engaged with a gripped object 600 according to particular embodiments of the present disclosure where the gripped object 600 is engaged by a proximal gripper surface 380-1 and a distal gripper surface 380-2.

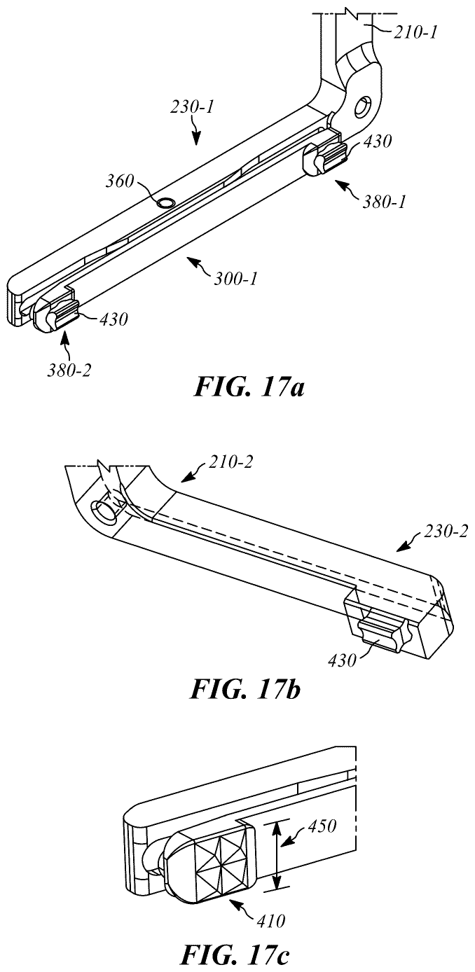

FIGS. 17a-17c illustrate schematic partial perspective views of examples of gripper surfaces according to particular embodiments of the present disclosure.

In particular embodiments, a gripper finger may be provided with one or more gripper pads comprising relatively soft and/or compliant materials, and/or a material capable of deforming under load. By way of example and not limitation, as illustrated in FIGS. 17a-17b, a compliant gripper pad 430 can be provided on a gripper surface. In particular embodiments, gripper surface 380 and/or compliant gripper pad 430 can comprise an elastomeric material, such as Buna-N rubber as a non-limiting example. In particular embodiments, a suitable hard material for gripper surface 380 may comprise a hardness of Durometer 70A (medium), or a reasonable substitute based on engineering design. In particular embodiments, a suitable material for compliant gripper pad 430 may be corrosion resistant, such as for operating in particular sample-handling environments and applications.

In particular embodiments, a compliant gripper pad 430 can comprise a particular shape, such as a suitable cross-sectional profile, to facilitate deformation of compliant gripper pad 430 under load, and/or to facilitate assembly and retention of a gripper pad. By way of example and not limitation, as illustrated in FIGS. 17a-17b, a compliant gripper pad 430 having an X-shaped profile can be accordingly provided, having a portion of the cross-sectional profile embedded within the corresponding contact section 230-2 of the gripper finger 210-2. In particular embodiments, a circular or square shaped profile of gripper pad 430 may be provided.

In particular embodiments, a gripper surface and/or a gripper pad can comprise relatively hard and/or rigid materials. In particular embodiments, a gripper surface and/or a pad material may comprise a material capable of resisting deformation under load, such as a metal, plastic, and/or ceramic, and/or any suitable materials or combinations for the intended applications and designs disclosed herein. In particular embodiments, a suitable material for gripper surface 380 and/or gripper pad 410 may be corrosion resistant, such as for operating in particular sample-handling environments and applications.

By way of non-limiting example, gripper surface 380 and/or gripper pad 410 can comprise a corrosion resistant stainless steel, such as 18-8 stainless steel. In particular embodiments, a suitable hard material for gripper surface 380 and/or gripper pad 410 may comprise a hardness of Rockwell B80, or a reasonable substitute based on engineering design. In particular embodiments, a suitable hard material for gripper surface 380 and/or gripper pad 410 may comprise a Young's module of 200 GPa±20%, or a reasonable substitute based on engineering design. In particular embodiments, a suitable hard material for gripper surface 380 and/or gripper pad 410 may comprise an yield strength of 200 MPa±20%, or a reasonable substitute based on engineering design.

By way of non-limiting example, gripper surface 380 and/or gripper pad 410 can comprise a high-performance engineering plastic, such as PEEK. In particular embodiments, a suitable hard material for gripper surface 380 and/or gripper pad 410 may comprise a hardness of Rockwell R126, or a reasonable substitute based on engineering design. In particular embodiments, a suitable hard material for gripper surface 380 and/or gripper pad 410 may comprise a tensile strength of 14 kPsi±20%, or a reasonable substitute based on engineering design.

In particular embodiments, a gripper surface can comprise one or more surface features having one or more edges, points, and/or other suitable features to facilitate gripping and/or cooperative engagement with an interfacing surface of a gripped object 600. In particular embodiments, one or more surface features of a gripper surface may converge at a tip or an edge toward the respective interfacing surface of a gripped object 600. By way of example and not limitation, FIG. 17c depicts a gripper pad 410 having multiple surface features converging to tips or points, such that gripper pad 410 can better grip and/or engage with an interfacing surface of a gripped object 600. In particular embodiments, a gripper surface height 450 may be selected based on one or more features of a gripped object 600. By way of example and not limitation, as previously disclosed, gripper surface height 450 can be selected based on a difference of an upper section height 560 of a microplate 510 and a microplate lid thickness 570 of a microplate lid 520.

### 3. End-Effector Teaching Jig

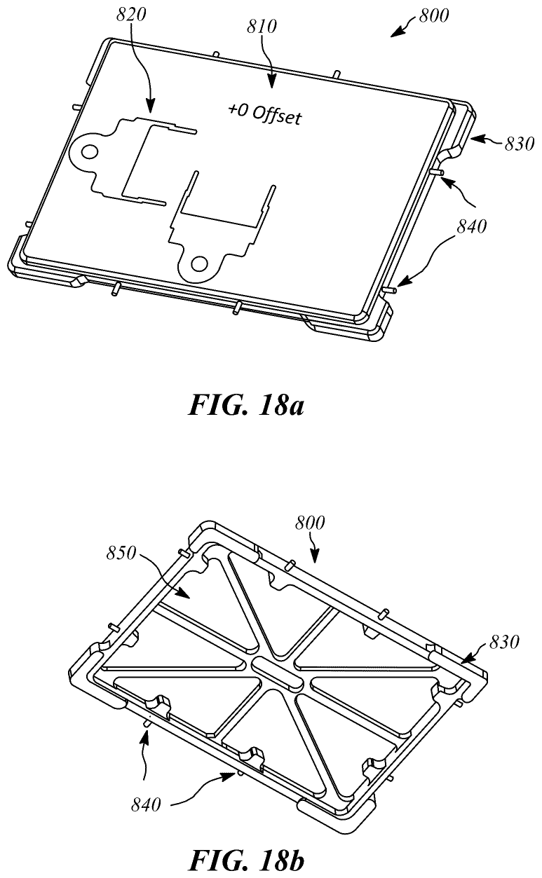

FIGS. 18a-18b illustrate schematic top perspective and bottom perspective views, respectively, of a teaching jig for a robotic system according to particular embodiments of the present disclosure. In certain embodiments, a teaching jig 800 of the present disclosure is used to ensure dimensional calibration of an end-effector 140 relative to a corresponding gripped object 600 for proper orientation and positioning of the end-effectors and associated sample-handling robots of the present disclosure. For example, having closed the gripper fingers of end-effector 140 such that teaching jig 800 is securely gripped by the gripper fingers, the robotic system 5 can register the corresponding minimum separation distance to accordingly calibrate one or more geometric parameters of interest associated with gripped object 600.

In certain embodiments, based on emulating particular features of a gripped object 600, such as a microplate assembly 500, teaching jig 800 can include geometric features such as cutouts, clearances, flanges, and/or differential dimensions. By way of example and not limitation, the bottom outside flange 830 of the teaching jig illustrated in FIGS. 18a-18b as non-limiting examples is interrupted to allow one or more gripper fingers of the end-effectors of the present disclosure to travel to open around particular indexing features of teaching jig 800, such as locating dowels 840, and then close tight on the jig. In certain embodiments, locating dowels 840 can be used to repeatably locate the jig to one or more grippers of the end-effectors of the present disclosure and can define “zero” gripper offset when teaching.

In certain embodiments, the jig is portrait grip compatible, landscape grip compatible, or both portrait and landscape grip compatible. Thus, in certain embodiments, multiple grip orientations of a gripped object 600 can be calibrated with same teaching jig.

In certain embodiments, engraved graphics, such as scribed offset 810 and/or scribed orientations 820 illustrated by way of non-limiting example in FIG. 18a, can be employed to instruct acceptable installation orientations and can be used to label the jig with a specified offset. In certain embodiments, the jig can be lightweighted, cored out, and/or ribbed to facilitate weight reduction while providing suitable structural integrity, such as illustrated by structural features 850 in FIG. 18b. In certain embodiments, chamfered corners can be employed at one or more corner of the jig to minimize risk of damage during handling.

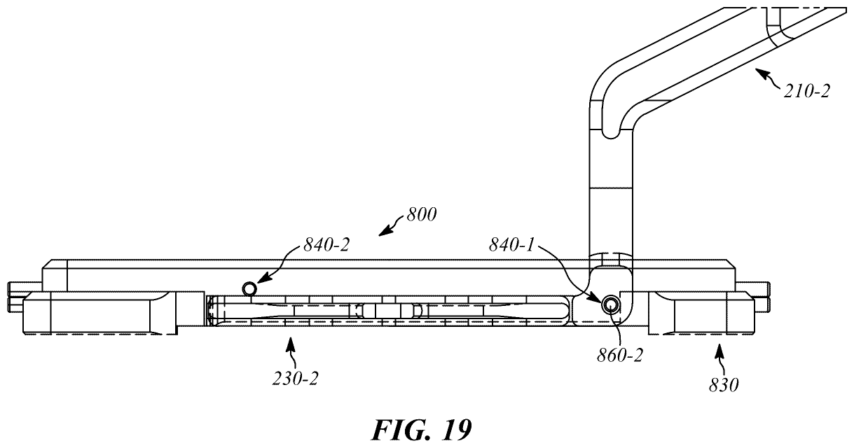

FIG. 19 illustrates a schematic side phantom view of a teaching jig gripped by a gripper finger for calibrating an end-effector according to particular embodiments of the present disclosure. As illustrated by way of non-limiting example in FIG. 19, indexing pins 840-1 (proximal) and 840-2 (distal) can be mated with a gripping finger 210-2 for calibration. By way of example and not limitation, such mating can occur via insertion of a pin into a corresponding indexing hole, e.g., proximal indexing pin 840-1 of teaching jig 800, as illustrated, can be inserted into indexing hole 860-2 of gripper finger 210-2, and/or via resting a pin on a portion of the gripper finger, e.g., resting distal indexing pin 840-2 of teaching jig 800 on contact section 230-2 of the gripper finger 210-2, as is also illustrated in FIG. 19.

### 4. Computer System-Controlled End-Effectors

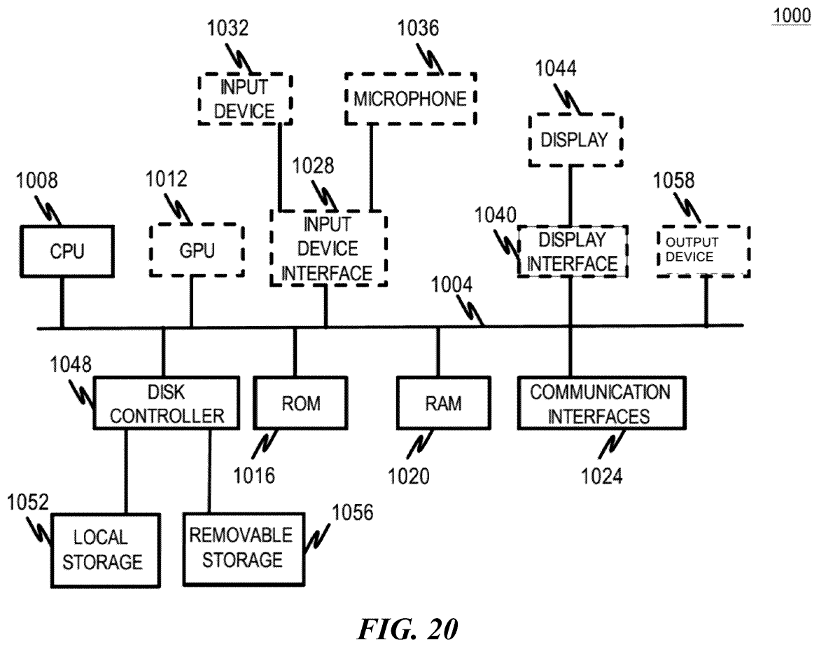

FIG. 20 illustrates a schematic computer system 1000 of a robotic system 5, according to particular embodiments of the present disclosure, as a non-limiting example of a computing device architecture for implementing various aspects of the compositions and methods described herein. In certain embodiments, a bus 1004 can serve as the information highway interconnecting the other illustrated components of the hardware. A processing system 1008 labeled CPU (central processing unit) (e.g., one or more computer processors/data processors at a given computer or at multiple computers), can perform calculations and logic operations required to execute a program. Optionally or additionally, a processing system 1012 labeled GPU (graphics processing unit) (e.g., one or more computer processors/data processors at a given computer or at multiple computers), can perform calculations and logic operations required to execute a program. A non-transitory processor-readable storage medium, such as read only memory (ROM) 1016 and random-access memory (RAM) 1020, can be in communication with the processing system 1008 and/or processing system 1012 and can include one or more programming instructions for the operations specified here. Optionally, program instructions can be stored on a non-transitory computer-readable storage medium such as a magnetic disk, optical disk, recordable memory device, flash memory, solid state drive or other physical storage medium.

In certain embodiments, a disk controller 1048 can interface with one or more optional removable storage 1056 or local storage 1052 to the system bus 1004. The removable storage 1056 can be external or internal disk drives, or solid-state drives, or external hard drives. The local storage 1052 can be internal hard drives and/or memory. As indicated previously, these various examples of removable storage 1056, local storage 1052, and disk controllers 1048 are optional devices. The system bus 1004 can also include at least one communications interface 1024 to allow for communication with external devices either physically connected to the computing system or available externally through a wired or wireless network such as cloud storage and remote services. In some cases, the at least one communications interface 1024 includes or otherwise comprises a network interface.

In certain embodiments, e.g., to provide for interaction with a user, the subject matter described herein can be implemented on a computing device having a display device 1044 (e.g., LCD (liquid crystal display) or LED (light-emitting diode) monitor) for displaying information obtained from the bus 1004 via a display interface 1040 to the user and an input device 1032 such as keyboard and/or a pointing device (e.g., a mouse or a trackball) and/or a touchscreen by which the user can provide input to the computer. Other kinds of input devices 1032 can be used to provide for interaction with a user as well; for example, feedback provided to the user can be any form of sensory feedback (e.g., visual feedback, auditory feedback by way of a microphone 1036, or tactile feedback); and input from the user can be received in any form, including acoustic, speech, or tactile input. The input device 1032 and the microphone 1036 can be coupled to and convey information, e.g., information concerning the workflow path desired for the end-effectors and/or other aspects of a sample-handling robotic system, via the bus 1004 by way of an input device interface 1028. An output device 1058 can convey instructions to control the movement of the end effectors and/or other aspects of sample-handling robotic systems of the present disclosure.

### 5. Exemplary Embodiments

In certain embodiments, the subject matter of the present disclosure is directed to an end-effector for a sample-handling robotic system, the end-effector comprising: a first gripper finger; and a second gripper finger, the first and second gripper fingers configured to be selectively separable from each other, each of the first gripper finger and the second gripper finger respectively comprising an extended member having an attachment end and a contact section opposite the attachment end, wherein the first gripper finger further comprises a rocker assembly comprising: a rocker member having a proximal portion and a distal portion; a pivoting connector assembly disposed between the proximal portion and the distal portion of the rocker member and configured to pivotally couple the rocker member to the contact section of the first gripper finger; and a proximal gripper surface and a distal gripper surface respectively provided at the proximal portion and the distal portion of the rocker member, wherein the second gripper finger further comprises an intermediate gripper surface provided at the contact section of the second gripper finger, the intermediate gripper surface disposed between parallel planes respectively passing through the proximal gripper surface and the distal gripper surface, and wherein each of the proximal, intermediate, and distal gripper surfaces is configured to cooperatively engage with a respective interfacing surface. In certain of embodiments, at least one gripper surface comprises one or more surface features to facilitate cooperative engagement with the respective interfacing surface, each of the one or more surface features converging toward the respective interfacing surface at a tip or an edge. In certain of embodiments, at least one gripper surface comprises a metallic gripper pad or a plastic gripper pad. In certain embodiments, at least one gripper surface comprises a gripper pad made of an elastomeric material capable of deforming under load to facilitate cooperative engagement with the respective interfacing surface. In certain embodiments, the pivoting connector assembly comprises a pin, a longitudinal motion of the pin constrained by at least one end of the pin engaging with a plastically deformed portion of the contact section. In certain embodiments, the rocker member pivots about the pivoting connector assembly based on the end-effector gripping a microplate assembly such that respective loads received at the proximal gripper surface and the distal gripper surface are balanced. In certain embodiments, the rocker member is provided with a ridge and the contact section is provided with a recess facing the ridge, the recess configured to receive the ridge based on the rocker member pivoting about the pivoting connector assembly. In certain embodiments, the ridge comprises a continuous projection on a side of the rocker member opposite each of the proximal gripper surface and the distal gripper surface. In certain embodiments, the ridge comprises a plurality of projections on the rocker member, and the contact section comprises a plurality of recesses, each recess of the plurality of recesses respectively configured to receive corresponding ones of the plurality of projections. In certain embodiments, the recess of the contact section receiving the ridge of the rocker member permits an increased range of maximum rotation of the rocker member about the pivoting connector assembly. In certain embodiments, a range of maximum rotation of the rocker member pivoting about the pivoting connector assembly is between 0.5 degrees and 10 degrees from a non-rotated position of the rocker member, the range of maximum rotation separately provided for a clockwise rotation or a counter-clockwise rotation from the non-rotated position. In certain embodiments, range of maximum rotation from the non-rotated position is symmetric based on equal respective values of the range of maximum rotation of the rocker member pivoting about the pivoting connector assembly in a clockwise direction of rotation and a counter-clockwise direction of rotation. In certain embodiments, a transition section connecting the contact section of each gripper finger to the respective attachment end comprises a portion of reduced cross-sectional area configured to prevent interference of the end-effector with an instrument or a microplate assembly. In certain embodiments, a respective height of each of the proximal, intermediate, and distal gripper surfaces is based on a gap between a microplate and a microplate lid when the microplate lid is assembled with the microplate. In certain embodiments, each of the first and second gripper fingers comprises hardened stainless steel or titanium. In certain embodiments, one or more of the interfacing surfaces are disposed on a microplate assembly comprising a microplate. In certain embodiments, the microplate assembly further comprises a microplate lid.

In certain embodiments, the presently disclosed subject matter is directed to a sample-handling robotic system comprising: a memory; a processor in communication with the memory; a robot in communication with the processor and configured to manipulate a plurality of microplate assemblies based on communication with the processor, the robot comprising: a robot arm operatively connected to the robot and configured to be positioned by the robot; and an end-effector operatively coupled to the robot arm, the end-effector comprising: a first gripper finger; and a second gripper finger, the first and second gripper fingers configured to be selectively separable from each other, each of the first gripper finger and the second gripper finger respectively comprising an extended member having an attachment end and a contact section opposite the attachment end, wherein the first gripper finger further comprises a rocker assembly comprising: a rocker member having a proximal portion and a distal portion; a pivoting connector assembly disposed between the proximal portion and the distal portion of the rocker member and configured to pivotally couple the rocker member to the contact section of the first gripper finger; and a proximal gripper surface and a distal gripper surface respectively provided at the proximal portion and the distal portion of the rocker member, wherein the second gripper finger further comprises an intermediate gripper surface provided at the contact section of the second gripper finger, the intermediate gripper surface disposed between parallel planes respectively passing through the proximal gripper surface and the distal gripper surface, and wherein each of the proximal, intermediate, and distal gripper surfaces is configured to cooperatively engage with a respective interfacing surface. In certain embodiments, at least one gripper surface comprises one or more surface features to facilitate cooperative engagement with the respective interfacing surface, each of the one or more surfaces features converging toward the microplate assembly at a tip or an edge. In certain embodiments, at least one gripper surface comprises a metallic gripper pad or a plastic gripper pad. In certain embodiments, at least one gripper surface comprises a gripper pad made of an elastomeric material capable of deforming under load to facilitate cooperative engagement with the respective interfacing surface. In certain embodiments, the pivoting connector assembly comprises a pin, a longitudinal motion of the pin constrained by at least one end of the pin engaging with a plastically deformed portion of the contact section. In certain embodiments, the rocker member pivots about the pivoting connector assembly based on the end-effector gripping a microplate assembly such that respective loads received at the proximal gripper surface and the distal gripper surface are balanced. In certain embodiments, the rocker member is provided with a ridge and the contact section is provided with a recess facing the ridge, the recess configured to receive the ridge based on the rocker member pivoting about the pivoting connector assembly. In certain embodiments, the recess of the contact section receiving the ridge of the rocker member permits an increased range of maximum rotation of the rocker member about the pivoting connector assembly. In certain embodiments, a transition section connecting the contact section of each gripper finger to the respective attachment end comprises a portion of reduced cross-sectional area configured to prevent interference of the end-effector with an instrument or a microplate assembly. In certain embodiments, a respective height of each of the proximal, intermediate, and distal gripper surfaces is based on a gap between a microplate and a microplate lid when the microplate lid is assembled with the microplate. In certain embodiments, each of the first and second gripper fingers comprises hardened stainless steel or titanium. In certain embodiments, one or more of the interfacing surfaces are disposed on a microplate assembly comprising a microplate. In certain embodiments, the microplate assembly further comprises a microplate lid.

In certain embodiments, the present disclosure is directed to a method of operating a robotic system comprising an end-effector, the method comprising: gripping a microplate assembly by a plurality of gripper surfaces, the plurality of gripper surfaces comprising a proximal gripper surface and a distal gripper surface provided on a rocker member, the rocker member pivotally coupled to a first gripper finger of the end-effector, the plurality of gripper surfaces further comprising an intermediate gripper surface coupled to a second gripper finger of the end-effector, the intermediate gripper surface disposed between parallel planes respectively passing through the proximal gripper surface and the distal gripper surface; mechanically aligning the rocker member based on the robotic system gripping the microplate assembly such that respective loads received at the proximal gripper surface and the distal gripper surface of the rocker member are balanced; and operating one or more robot arms of the robotic system to provide one or more positional changes to the microplate assembly, wherein the end-effector is operatively coupled to aa robot arm of the one or more robot arms. In certain embodiments, prior to gripping the microplate assembly, separating the first gripper finger and the second gripper finger to accommodate the microplate assembly. In certain embodiments, the microplate assembly is gripped by decreasing a separation between the first gripper finger and the second gripper finger such that the microplate assembly is engaged by the plurality of gripper surfaces. In certain embodiments, one or more positional changes are provided by the one or more robot arms of the robotic system such that a lid is assembled on a microplate or the lid is disassembled from the microplate, the microplate assembly comprising the lid and the microplate. In certain embodiments, one or more positional changes are provided by the one or more robot arms of the robotic system such that the microplate assembly is lowered into a recessed enclosure of an instrument or raised from the recessed enclosure of the instrument, wherein each of the first and second gripper fingers respectively comprises an attachment end and a contact section provided opposite the attachment end, the proximal gripper surface and the distal gripper surface disposed at the contact section of the first gripper finger, the intermediate gripper surface disposed at the contact section of the second gripper finger, and wherein the attachment end of each of the first and second gripper fingers is configured to be vertically offset from the respective contact section to facilitate access to the recessed enclosure of the instrument. In certain embodiments, one or more positional changes are provided by the one or more robot arms of the robotic system such that the microplate assembly is inserted into a recessed enclosure of an instrument or retrieved from the recessed enclosure of the instrument, wherein each of the first and second gripper fingers respectively comprises an attachment end and a contact section provided opposite the attachment end, the proximal gripper surface and the distal gripper surface disposed at the contact section of the first gripper finger, the intermediate gripper surface disposed at the contact section of the second gripper finger, and wherein the attachment end of each of the first and second gripper fingers is configured to be horizontally offset from the respective contact section to facilitate access to the recessed enclosure of the instrument. In certain embodiments, the microplate assembly is gripped by the plurality of gripper surfaces of the robotic system engaging a pair of opposing sides of a microplate, the pair of opposing sides being parallel to a lengthwise axis of the microplate, wherein the lengthwise axis is longer than a widthwise axis of the microplate. In certain embodiments, the microplate assembly is gripped by the plurality of gripper surfaces of the robotic system engaging a pair of opposing sides of a microplate, the pair of opposing sides being parallel to a widthwise axis of the microplate, wherein the widthwise axis is shorter than a lengthwise axis of the microplate. In certain embodiments, at least one gripper surface of the plurality of gripper surfaces gripping the microplate assembly comprises one or more surface features to facilitate cooperative engagement with a respective interfacing surface of the microplate assembly, each of the one or more surface features converging toward the microplate assembly at a a tip or an edge. In certain embodiments, at least one gripper surface of the plurality of gripper surfaces gripping the microplate assembly comprises a metallic gripper pad or a plastic gripper pad. In certain embodiments, at least one gripper surface of the plurality of gripper surfaces gripping the microplate assembly comprises a gripper pad made of an elastomeric material capable of deforming under load to facilitate cooperative engagement with a respective interfacing surface of the microplate assembly. In certain embodiments, mechanical alignment of the rocker member is facilitated by the rocker member pivoting about a pin, and wherein a longitudinal motion of the pin is constrained by at least one end of the pin engaging with a plastically deformed portion of the first gripper finger.

In certain embodiments, the present disclosure is directed to an end-effector for a sample-handling robotic system, the end-effector comprising: a first gripper finger; and a second gripper finger, the first and second gripper fingers configured to be selectively separable from each other, each of the first gripper finger and the second gripper finger respectively comprising an extended member having an attachment end and a contact section opposite the attachment end, the contact section vertically offset from the attachment end, wherein each of the first gripper finger and the second gripper finger further comprises a rocker assembly, each rocker assembly respectively comprising: a rocker member having a proximal portion and a distal portion; a pivoting connector assembly disposed between the proximal portion and the distal portion of the rocker member and configured to pivotally couple the rocker member to the contact section of the respective gripper finger; and a proximal gripper surface and a distal gripper surface respectively provided at the proximal portion and the distal portion of the rocker member, each of the proximal and distal gripper surfaces configured to cooperatively engage with a respective interfacing. In certain embodiments, at least one gripper surface comprises one or more surface features to facilitate cooperative engagement with the respective interfacing surface of a microplate assembly, each of the one or more surface features converging toward the microplate assembly at a tip or an edge. In certain embodiments, at least one gripper surface comprises a metallic gripper pad or a plastic gripper pad. In certain embodiments, at least one gripper surface comprises a gripper pad made of an elastomeric material capable of deforming under load to facilitate cooperative engagement with the respective interfacing surface of a microplate assembly. In certain embodiments, each of the pivoting connector assemblies comprises a pin, a longitudinal motion of each pin constrained by at least one end of the pin engaging with a plastically deformed portion of the respective contact section. In certain embodiments, each rocker member pivots about the respective pivoting connector assembly based on the end-effector gripping a microplate assembly such that respective loads received at the proximal gripper surface and the distal gripper surface of the respective rocker member are balanced. In certain embodiments, one or more of the interfacing surfaces are disposed on a microplate assembly comprises a microplate.

### 6. Examples

### 6.1 Example 1

This example describes the use of an end-effector of the present disclosure in connection with a sample handling robot manipulating microplates and other objects, e.g., pipette tip containers, to facilitate a high throughput laboratory screening analysis.

FIG. 1 illustrates a sample-handling robot comprising an end-effector capable of manipulating microplates and other objects, e.g., pipette tip containers, to facilitate a high throughput laboratory screening analysis. In particular, the end-effector of FIG. 1 is configured to engage with microplates to facilitate movement of the microplate to a variety of instruments. These instruments include: a plate hotel, a microplate lid hotel, a plate sealer, an incubator, a seal peeler, a carousel, and a plate washer. To facilitate the various portrait and landscape gripping orientations, the end effector 140 comprises gripper fingers 210-1 and 210-2 capable of engaging the microplate. Movement about the plane of the base 110 is facilitated by movement of the vertical stage 120 and the various components of the robotic arm 130 (including articulating members of the robotic arm 130-1, 130-2, and 130-3). FIGS. 4-7 illustrate exemplary engagement of the end-effector 140 with microplates and their movement to a variety of instruments.

Although the presently disclosed subject matter and its advantages have been described in detail, it should be understood that various changes, substitutions and alterations can be made herein without departing from the spirit and scope of the present disclosure. Moreover, the scope of the present application is not intended to be limited to the particular embodiments of the process, machine, manufacture, and composition of matter, means, methods and steps described in the specification. As one of ordinary skill in the art will readily appreciate from the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

Various patents, patent applications, publications, product descriptions, protocols, and sequence accession numbers are cited throughout this application, the contents of which are incorporated by reference in their entirety for all purposes.

1. An end-effector for a sample-handling robotic system, the end-effector comprising:
a first gripper finger; and
a second gripper finger, the first and second gripper fingers configured to be selectively separable from each other, each of the first gripper finger and the second gripper finger respectively comprising an extended member having an attachment end and a contact section opposite the attachment end,
wherein the first gripper finger further comprises a rocker assembly comprising:
a rocker member having a proximal portion and a distal portion;
a pivoting connector assembly disposed between the proximal portion and the distal portion of the rocker member and configured to pivotally couple the rocker member to the contact section of the first gripper finger; and
a proximal gripper surface and a distal gripper surface respectively provided at the proximal portion and the distal portion of the rocker member,
wherein the second gripper finger further comprises an intermediate gripper surface provided at the contact section of the second gripper finger, the intermediate gripper surface disposed between parallel planes respectively passing through the proximal gripper surface and the distal gripper surface, and
wherein each of the proximal, intermediate, and distal gripper surfaces is configured to cooperatively engage with a respective interfacing surface.

2. The end-effector of claim 1, wherein at least one gripper surface comprises one or more surface features to facilitate cooperative engagement with the respective interfacing surface, each of the one or more surface features converging toward the respective interfacing surface at a tip or an edge.

3. The end-effector of claim 2, wherein the at least one gripper surface comprises a metallic gripper pad or a plastic gripper pad.

4. The end-effector of claim 1, wherein at least one gripper surface comprises a gripper pad made of an elastomeric material capable of deforming under load to facilitate cooperative engagement with the respective interfacing surface.

5. The end-effector of claim 1, wherein the pivoting connector assembly comprises a pin, a longitudinal motion of the pin constrained by at least one end of the pin engaging with a plastically deformed portion of the contact section.

6. The end-effector of claim 1, wherein the rocker member pivots about the pivoting connector assembly based on the end-effector gripping a microplate assembly such that respective loads received at the proximal gripper surface and the distal gripper surface are balanced.

7. The end-effector of claim 6, wherein the rocker member is provided with a ridge and the contact section is provided with a recess facing the ridge, the recess configured to receive the ridge based on the rocker member pivoting about the pivoting connector assembly.

8. The end-effector of claim 7, wherein the ridge comprises a continuous projection on a side of the rocker member opposite each of the proximal gripper surface and the distal gripper surface.

9. The end-effector of claim 7, wherein the ridge comprises a plurality of projections on the rocker member, and the contact section comprises a plurality of recesses, each recess of the plurality of recesses respectively configured to receive corresponding ones of the plurality of projections.

10. The end-effector of claim 7, wherein the recess of the contact section receiving the ridge of the rocker member permits an increased range of maximum rotation of the rocker member about the pivoting connector assembly.

11. The end-effector of claim 1, wherein a range of maximum rotation of the rocker member pivoting about the pivoting connector assembly is between 0.5 degrees and 10 degrees from a non-rotated position of the rocker member, the range of maximum rotation separately provided for a clockwise rotation or a counter-clockwise rotation from the non-rotated position.

12. The end-effector of claim 11, wherein the range of maximum rotation from the non-rotated position is symmetric based on equal respective values of the range of maximum rotation of the rocker member pivoting about the pivoting connector assembly in a clockwise direction of rotation and a counter-clockwise direction of rotation.

13. The end-effector of claim 1, wherein a transition section connecting the contact section of each gripper finger to the respective attachment end comprises a portion of reduced cross-sectional area configured to prevent interference of the end-effector with an instrument or a microplate assembly.

14. The end-effector of claim 1, wherein a respective height of each of the proximal, intermediate, and distal gripper surfaces is based on a gap between a microplate and a microplate lid when the microplate lid is assembled with the microplate.

15. The end-effector of claim 1, wherein each of the first and second gripper fingers comprises hardened stainless steel or titanium.

16. The end-effector of claim 1, wherein one or more of the interfacing surfaces are disposed on a microplate assembly comprising a microplate.

17. The end-effector of claim 16, wherein the microplate assembly further comprises a microplate lid.

18. A sample-handling robotic system comprising:
a memory;
a processor in communication with the memory;
a robot in communication with the processor and configured to manipulate a plurality of microplate assemblies based on communication with the processor, the robot comprising:
a robot arm operatively connected to the robot and configured to be positioned by the robot; and
an end-effector operatively coupled to the robot arm, the end-effector comprising:
a first gripper finger; and
a second gripper finger, the first and second gripper fingers configured to be selectively separable from each other, each of the first gripper finger and the second gripper finger respectively comprising an extended member having an attachment end and a contact section opposite the attachment end,
wherein the first gripper finger further comprises a rocker assembly comprising:
a rocker member having a proximal portion and a distal portion;
a pivoting connector assembly disposed between the proximal portion and the distal portion of the rocker member and configured to pivotally couple the rocker member to the contact section of the first gripper finger; and
a proximal gripper surface and a distal gripper surface respectively provided at the proximal portion and the distal portion of the rocker member,
wherein the second gripper finger further comprises an intermediate gripper surface provided at the contact section of the second gripper finger, the intermediate gripper surface disposed between parallel planes respectively passing through the proximal gripper surface and the distal gripper surface, and
wherein each of the proximal, intermediate, and distal gripper surfaces is configured to cooperatively engage with a respective interfacing surface.

19. The sample-handling robotic system of claim 18, wherein at least one gripper surface comprises one or more surface features to facilitate cooperative engagement with the respective interfacing surface, each of the one or more surfaces features converging toward the microplate assembly at a tip or an edge.

20. The sample-handling robotic system of claim 19, wherein the at least one gripper surface comprises a metallic gripper pad or a plastic gripper pad.

21. The sample-handling robotic system of claim 18, wherein at least one gripper surface comprises a gripper pad made of an elastomeric material capable of deforming under load to facilitate cooperative engagement with the respective interfacing surface.

22. The sample-handling robotic system of claim 18, wherein the pivoting connector assembly comprises a pin, a longitudinal motion of the pin constrained by at least one end of the pin engaging with a plastically deformed portion of the contact section.

23. The sample-handling robotic system of claim 18, wherein the rocker member pivots about the pivoting connector assembly based on the end-effector gripping a microplate assembly such that respective loads received at the proximal gripper surface and the distal gripper surface are balanced.

24. The end-effector of claim 23, wherein the rocker member is provided with a ridge and the contact section is provided with a recess facing the ridge, the recess configured to receive the ridge based on the rocker member pivoting about the pivoting connector assembly.

25. The end-effector of claim 7, wherein the recess of the contact section receiving the ridge of the rocker member permits an increased range of maximum rotation of the rocker member about the pivoting connector assembly.

26. The sample-handling robotic system of claim 18, wherein a transition section connecting the contact section of each gripper finger to the respective attachment end comprises a portion of reduced cross-sectional area configured to prevent interference of the end-effector with an instrument or a microplate assembly.

27. The sample-handling robotic system of claim 18, wherein a respective height of each of the proximal, intermediate, and distal gripper surfaces is based on a gap between a microplate and a microplate lid when the microplate lid is assembled with the microplate.

28. The sample-handling robotic system of claim 18, wherein each of the first and second gripper fingers comprises hardened stainless steel or titanium.

29. The sample-handling robotic system of claim 18, wherein one or more of the interfacing surfaces are disposed on a microplate assembly comprising a microplate.

30. The sample-handling robotic system of claim 29, wherein the microplate assembly further comprises a microplate lid.

31. A method of operating a robotic system comprising an end-effector, the method comprising:
gripping a microplate assembly by a plurality of gripper surfaces, the plurality of gripper surfaces comprising a proximal gripper surface and a distal gripper surface provided on a rocker member, the rocker member pivotally coupled to a first gripper finger of the end-effector, the plurality of gripper surfaces further comprising an intermediate gripper surface coupled to a second gripper finger of the end-effector, the intermediate gripper surface disposed between parallel planes respectively passing through the proximal gripper surface and the distal gripper surface;
mechanically aligning the rocker member based on the robotic system gripping the microplate assembly such that respective loads received at the proximal gripper surface and the distal gripper surface of the rocker member are balanced; and
operating one or more robot arms of the robotic system to provide one or more positional changes to the microplate assembly, wherein the end-effector is operatively coupled to aa robot arm of the one or more robot arms.

32. The method of claim 31 further comprising, prior to gripping the microplate assembly, separating the first gripper finger and the second gripper finger to accommodate the microplate assembly.

33. The method of claim 31, wherein the microplate assembly is gripped by decreasing a separation between the first gripper finger and the second gripper finger such that the microplate assembly is engaged by the plurality of gripper surfaces.

34. The method of claim 31, wherein the one or more positional changes are provided by the one or more robot arms of the robotic system such that a lid is assembled on a microplate or the lid is disassembled from the microplate, the microplate assembly comprising the lid and the microplate.

35. The method of claim 31, wherein the one or more positional changes are provided by the one or more robot arms of the robotic system such that the microplate assembly is lowered into a recessed enclosure of an instrument or raised from the recessed enclosure of the instrument,
wherein each of the first and second gripper fingers respectively comprises an attachment end and a contact section provided opposite the attachment end, the proximal gripper surface and the distal gripper surface disposed at the contact section of the first gripper finger, the intermediate gripper surface disposed at the contact section of the second gripper finger, and
wherein the attachment end of each of the first and second gripper fingers is configured to be vertically offset from the respective contact section to facilitate access to the recessed enclosure of the instrument.

36. The method of claim 31, wherein the one or more positional changes are provided by the one or more robot arms of the robotic system such that the microplate assembly is inserted into a recessed enclosure of an instrument or retrieved from the recessed enclosure of the instrument,
wherein each of the first and second gripper fingers respectively comprises an attachment end and a contact section provided opposite the attachment end, the proximal gripper surface and the distal gripper surface disposed at the contact section of the first gripper finger, the intermediate gripper surface disposed at the contact section of the second gripper finger, and
wherein the attachment end of each of the first and second gripper fingers is configured to be horizontally offset from the respective contact section to facilitate access to the recessed enclosure of the instrument.

37. The method of claim 31, wherein the microplate assembly is gripped by the plurality of gripper surfaces of the robotic system engaging a pair of opposing sides of a microplate, the pair of opposing sides being parallel to a lengthwise axis of the microplate, wherein the lengthwise axis is longer than a widthwise axis of the microplate.

38. The method of claim 31, wherein the microplate assembly is gripped by the plurality of gripper surfaces of the robotic system engaging a pair of opposing sides of a microplate, the pair of opposing sides being parallel to a widthwise axis of the microplate, wherein the widthwise axis is shorter than a lengthwise axis of the microplate.

39. The method of claim 31, wherein at least one gripper surface of the plurality of gripper surfaces gripping the microplate assembly comprises one or more surface features to facilitate cooperative engagement with a respective interfacing surface of the microplate assembly, each of the one or more surface features converging toward the microplate assembly at a a tip or an edge.

40. The method of claim 31, wherein at least one gripper surface of the plurality of gripper surfaces gripping the microplate assembly comprises a metallic gripper pad or a plastic gripper pad.

41. The method of claim 31, wherein at least one gripper surface of the plurality of gripper surfaces gripping the microplate assembly comprises a gripper pad made of an elastomeric material capable of deforming under load to facilitate cooperative engagement with a respective interfacing surface of the microplate assembly.

42. The method of claim 31, wherein mechanical alignment of the rocker member is facilitated by the rocker member pivoting about a pin, and wherein a longitudinal motion of the pin is constrained by at least one end of the pin engaging with a plastically deformed portion of the first gripper finger.

43. An end-effector for a sample-handling robotic system, the end-effector comprising:
a first gripper finger; and
a second gripper finger, the first and second gripper fingers configured to be selectively separable from each other, each of the first gripper finger and the second gripper finger respectively comprising an extended member having an attachment end and a contact section opposite the attachment end, the contact section vertically offset from the attachment end,
wherein each of the first gripper finger and the second gripper finger further comprises a rocker assembly, each rocker assembly respectively comprising:
a rocker member having a proximal portion and a distal portion;
a pivoting connector assembly disposed between the proximal portion and the distal portion of the rocker member and configured to pivotally couple the rocker member to the contact section of the respective gripper finger; and
a proximal gripper surface and a distal gripper surface respectively provided at the proximal portion and the distal portion of the rocker member, each of the proximal and distal gripper surfaces configured to cooperatively engage with a respective interfacing.

44. The end-effector of claim 43, wherein at least one gripper surface comprises one or more surface features to facilitate cooperative engagement with the respective interfacing surface of a microplate assembly, each of the one or more surface features converging toward the microplate assembly at a tip or an edge.

45. The end-effector of claim 44, wherein the at least one gripper surface comprises a metallic gripper pad or a plastic gripper pad.

46. The end-effector of claim 43, wherein at least one gripper surface comprises a gripper pad made of an elastomeric material capable of deforming under load to facilitate cooperative engagement with the respective interfacing surface of a microplate assembly.

47. The end-effector of claim 43, wherein each of the pivoting connector assemblies comprises a pin, a longitudinal motion of each pin constrained by at least one end of the pin engaging with a plastically deformed portion of the respective contact section.

48. The end-effector of claim 43, wherein each rocker member pivots about the respective pivoting connector assembly based on the end-effector gripping a microplate assembly such that respective loads received at the proximal gripper surface and the distal gripper surface of the respective rocker member are balanced.

49. The end-effector of claim 43, wherein one or more of the interfacing surfaces are disposed on a microplate assembly comprises a microplate.
